(19) United States
(12) Patent Application Publication
(10) Pub. No.: US 2012/0246304 A1
(43) Pub. Date: Sep. 27, 2012

(54) SERVER MANAGEMENT APPARATUS AND METHOD, AND SERVER MANAGEMENT PROGRAM

(75) Inventor: Tomonori Mase, Kawasaki (JP)

(73) Assignee: FUJITSU LIMITED, Kawasaki-shi (JP)

(21) Appl. No.: 13/428,034

(22) Filed: Mar. 23, 2012

(30) Foreign Application Priority Data
Mar. 26, 2011 (JP) 2011-069033

(51) Int. Cl. G06F 15/173

(52) U.S. Cl. 709/224

(57) ABSTRACT

A server management apparatus that performs processing of collecting statuses of devices arranged in a target server system on the basis of a request received from an upper-level apparatus and transmits a result of the processing to the upper-level apparatus as a reply to the request, the server management apparatus includes a communication controller configured to perform a communication with the upper-level apparatus, and a processor configured, in a case where when the communication controller receives the request from the upper-level apparatus, a processing content of the request is the same as a processing content of a previously received request and a reply to the processing based on the previously received request has not been transmitted to the upper-level apparatus, to avoid starting the processing corresponding to the subsequently received request and continue the processing based on the previously received request.

### CROSS-REFERENCE TO RELATED APPLICATION

This application is based upon and claims the benefit of priority of the prior Japanese Patent Application No. 2011-069033, filed on Mar. 26, 2011, the entire contents of which are incorporated herein by reference.

### FIELD

The embodiment discussed herein is related to a server management apparatus and method.

### BACKGROUND

In a server system, a single server rack includes therein system boards such as a plurality of blade servers and an I/O (Input/Output) apparatus such as a hard disc drive (HDD) accessed by each of the system boards. In addition to these components, the server rack includes therein a power supply apparatus configured to supply power to the respective devices in the server rack, a fan designed to perform air ventilation in the server rack, and the like. In the following description, the above-mentioned system boards, the I/O apparatus, the power supply apparatus, and the fan accommodated in the server rack are collectively referred to as “devices”.

In the thus configured server system, various sensors such as temperature sensors are attached to check statuses of these devices.

The server rack also includes a server management apparatus configured to collect detection values from the various sensors in accordance with instructions from an upper-level apparatus such as a supervisor terminal.

This server management apparatus can communicate with the respective devices in the server rack by a bus such as an I2C (Inter-Integrated Circuit). When an instruction from the supervisor terminal is received via a network for a supervisor which is different from a network for a normal communication, the server management apparatus requests via an I2C 106 the respective devices corresponding to the instruction to obtain detection values of sensors. The respective devices receiving this request obtain detection values from the corresponding sensors and transmit the obtained detection values to the server management apparatus via the I2C 106. The server management apparatus receives and collects the detection values transmitted from the respective devices. The server management apparatus transmits as a response to the request the collected detection values via the dedicated-use network for the supervisor to the supervisor terminal that has made the request. See Japanese Laid-open Patent Publication No. 2006-178959 and Japanese Laid-open Patent Publication No. 2009-098985.

### SUMMARY

According to an aspect of the invention, a server management apparatus that performs processing of collecting statuses of devices arranged in a target server system on the basis of a request received from an upper-level apparatus and transmits a result of the processing to the upper-level apparatus as a reply to the request, the server management apparatus includes a communication controller configured to perform a communication with the upper-level apparatus; and a processor configured, in a case where when the communication controller receives the request from the upper-level apparatus, a processing content of the request is the same as a processing content of a previously received request and a reply to the processing based on the previously received request has not been transmitted to the upper-level apparatus, to avoid starting the processing corresponding to the subsequently received request and continue the processing based on the previously received request.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is an outline diagram of a server system according to the present embodiment;

FIG. 2 is an outline diagram of hardware of a server management apparatus according to the present embodiment;

FIG. 3 is a function block diagram of the server management apparatus according to the present embodiment;

FIG. 4 illustrates an example of a request transmitted from a supervisor terminal;

FIG. 5 illustrates an example of a response transmitted by the server management apparatus to the supervisor terminal;

FIG. 6 illustrates a sequence ID management table according to the present embodiment;

FIG. 7 illustrates a session management table according to the present embodiment;

FIG. 8 is a hardware conceptual diagram of the supervisor terminal according to the present embodiment;

FIG. 9 is a function block diagram of the supervisor terminal according to the present embodiment;

FIG. 10 is a processing flow chart of a command processing unit according to the present embodiment;

FIG. 11 illustrates the sequence ID management table according to the present embodiment;

FIG. 12 illustrates the sequence ID management table according to the present embodiment;

FIG. 13 illustrates a request according to the present embodiment;

FIG. 14 illustrates a request from the command processing unit to a session management unit according to the present embodiment;

FIG. 15 illustrates a response according to the present embodiment;

FIG. 16 illustrates a response addressed to the supervisor terminal according to the present embodiment;

FIG. 17 is a processing flow chart of the command processing unit according to the present embodiment;

FIG. 18 illustrates the request for a session establishment according to the present embodiment;

FIG. 19 illustrates the request for the session establishment to the session management unit according to the present embodiment;

FIG. 20 illustrates the response from the session management unit according to the present embodiment;

FIG. 21 illustrates the response addressed to the supervisor terminal according to the present embodiment;

FIG. 22 is a processing flow chart of the command processing unit according to the present embodiment;

FIG. 23 illustrates the normal request according to the present embodiment;

FIG. 24 illustrates the sequence ID management table according to the present embodiment;

FIG. 25 illustrates a request transmitted to a target device according to the present embodiment;

FIG. 26 is a processing flow chart of the command processing unit according to the present embodiment;

FIG. 27 is a processing flow chart of the command processing unit according to the present embodiment;

FIG. 28 illustrates a response from the respective devices according to the present embodiment;

FIG. 29 is a processing flow chart of the session management unit according to the present embodiment;

FIG. 30 is a processing flow chart of the session management unit according to the present embodiment;

FIG. 31 is a processing flow chart of the supervisor terminal according to the present embodiment;

FIG. 32 is a processing flow chart of the supervisor terminal according to the present embodiment;

FIG. 33 is a sequence chart of the server system according to the present embodiment; and

FIG. 34 is a sequence chart of the server system according to the present embodiment.

### DESCRIPTION OF EMBODIMENT

In the above-mentioned server system, if a response is not received from the server management apparatus for a period of time longer than or equal to a predetermined period of time, the upper-level apparatus performs the same request (reclaim/retry) in many cases by giving a consideration to a case in which the server management apparatus has not received a request from the upper-level apparatus because of a communication error or the like.

For this reason, even in a case where the server management apparatus receives a request from the upper-level apparatus and starts processing based on the request but the processing with respect to the request lasts long and the time exceeds the predetermined period of time, the upper-level apparatus transmits the reclaim. In a case where the reclaim is received, after the previous processing is abandoned, the server management apparatus may start the relevant processing again in some cases.

However, since the processing taking much time is simply started again, thereafter, the request for the reprocessing is delivered with respect to this processing from the upper-level apparatus and this processing is also abandoned. As a result, a response to the request from the upper-level apparatus is not carried out.

The present technology has been made in view of the point and provides a server management apparatus that can perform a response from a server management apparatus to an upper-level apparatus by effectively utilizing a processing result with respect to the previously received request even in a case where such prolonged processing is carried out and a response is not returned to an extent that a reclaim is carried out from the upper-level apparatus.

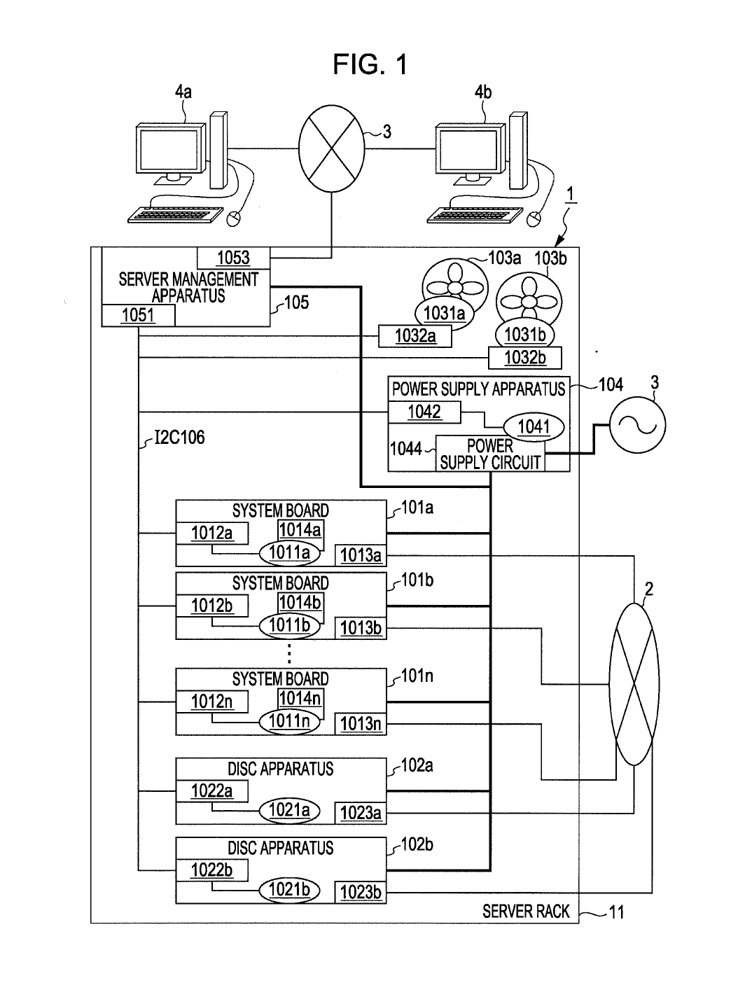

FIG. 1 is an outline diagram of a server system 1 according to the present embodiment.

As illustrated in FIG. 1, the present server system 1 has server rack 11.

The server rack 11 accommodates therein a plurality of system boards 101a to 101n such as blade servers, disc apparatuses 102a and 102b, fans 103a and 103b, a power supply apparatus 104, and a server management apparatus 105. (For the sake of convenience, these components are collectively referred to as “devices” in some cases.) Also, the server management apparatus 105 performs a communication with the respective devices via an I2C (Inter-Integrated Circuit) 106 that is one type of a bus.

Among these, the system boards 101a to 101n respectively have CPUs 1014a to 1014n and temperature sensors 1011a to 1011n configured to detect temperature sensors 1011a to 1011n of the CPUs 1014a to 1014n. Also, the system boards 101a to 101n respectively have communication interfaces 1012a to 1012n configured to perform a communication with the server management apparatus 105 via the I2C 106. By using the I2C 106, on the basis of the instruction received from the server management apparatus 105, the communication interfaces 1012a to 1012n respectively transmit detected temperature information from the temperature sensors 1011a to 1011n to the server management apparatus 105. Also, the system boards 101a to 101n have network adapters 1013a to 1013n configured to perform a communication for actual processing via a main network 2.

Also, the disc apparatuses 102a and 102b respectively have temperature sensors 1021a and 1021b configured to detect temperatures of main bodies of the disc apparatuses 102a and 102b. Also, the disc apparatuses 102a and 102b have communication interfaces 1022a and 1022b configured to perform a communication with the server management apparatus 105 via the I2C 106. On the basis of the instruction received from the server management apparatus 105 via the I2C 106, the communication interfaces 1022a and 1022b respectively transmit temperature information detected by the temperature sensors 1021a and 1021b to the server management apparatus 105 via the I2C 106. Also, the disc apparatuses 102a and 102b have network adapters 1023a and 1023b configured to perform a communication of a processing system via the main network 2.

Also, the fans 103a and 103b are fans designed to perform air ventilation in the server rack 11. The fans 103a and 103b respectively have speed sensors 1031a and 1031b configured to detect rotating speeds of the fans 103a and 103b. Also, the fans 103a and 103b have communication interfaces 1032a and 1032b configured to perform a communication with the server management apparatus 105 via the I2C 106. On the basis of the instruction received from the server management apparatus 105 via the I2C 106, the communication interfaces 1032a and 1032b respectively transmit speed information from the speed sensors 1031a and 1031b to the server management apparatus 105 via the I2C 106.

Furthermore, in the power supply apparatus 104, a power supply circuit 1044 connected to an external power source 3 and configured to supply power to the respective devices in the server rack is mounted. The power supply apparatus 104 has a voltage sensor 1041 configured to detect a feeding voltage of the external power source 3. Also, the power supply apparatus 104 has a communication interface 1042 configured to perform a communication with the server management apparatus 105 via the I2C 106. On the basis of the instruction received from the server management apparatus 105 via the I2C 106, the communication interface 1042 transmits voltage information detected by the voltage sensor 1041 to the server management apparatus 105 via the I2C 106.

It is noted that according to the present embodiment, for the sake of convenience for the description, the respective devices has one sensor, but for example, in the case of a hard disc apparatus, a plurality of sensors may be provided in one device to detect a rotating speed of a disc, a welding time, and the like.

The server management apparatus 105 transmits an instruction in accordance with the request (the request 10590: which will be described below) transmitted via a network 3 for a supervisor from a supervisor terminal 4a or 4b which is one type of an upper-level apparatus via the I2C 106 to the respective devices in the server rack 11. Also, the server management apparatus 105 collects information from the respective devices received via the I2C 106 to collect a response 10801 and transmits a collection result via the network 3 for the supervisor to the supervisor terminal 4a or 4b that has transmitted the request 10590.

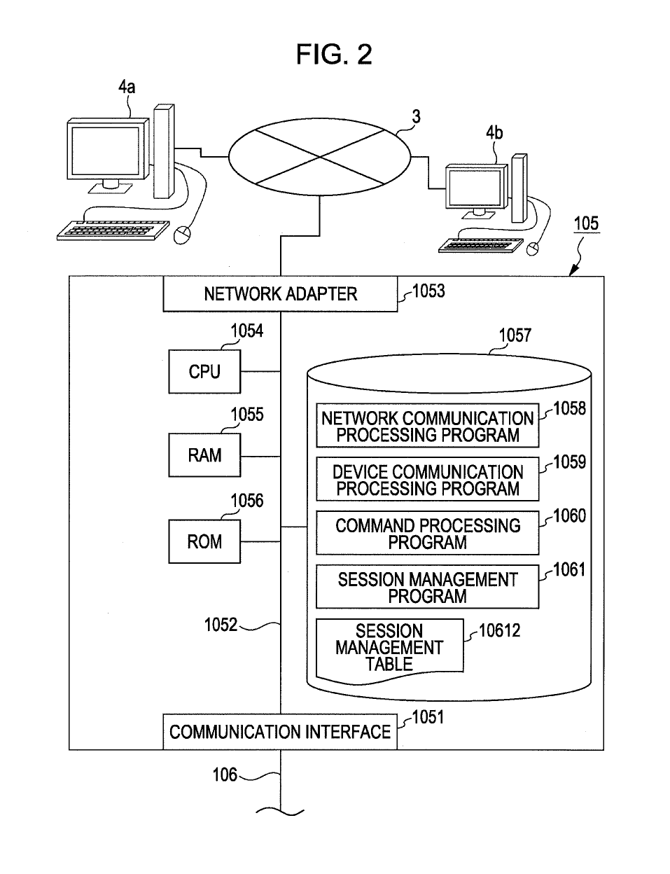

The server management apparatus 105 will be described below by using FIG. 2.

FIG. 2 is an outline diagram of hardware of the server management apparatus 105.

As illustrated in FIG. 2, the server management apparatus 105 has an internal bus 1052. a communication interface 1051, a network adapter 1053, a CPU (central processing unit) 1054, a RAM (random access memory) 1055, a ROM (read only memory) 1056, and a hard disc apparatus 1057 are connected to the internal bus 1052.

Among these, the communication interface 1051 is connected to the I2C 106 and performs a communication with the respective devices in the server rack 11 illustrated in FIG. 1. Also, the network adapter 1053 is connected to the network 3 for the supervisor and performs a communication with the supervisor terminal 4a or 4b via the network 3 for the supervisor.

The CPU 1054 executes various programs stored in the hard disc apparatus 1057. Also, along with the execution of the various programs stored in the hard disc apparatus 1057, the CPU 1054 appropriately performs access to the hard disc apparatus 1057, write and read of data to and from the RAM 1055, and read of data from the ROM 1056. Furthermore, along with the execution of these programs, the CPU 1054 appropriately performs a communication control for the network adapter 1053 and the communication interface 1051.

The programs stored in the hard disc apparatus 1057 include a network communication processing program 1058, a device communication processing program 1059, a command processing program 1060, and a session management program 1061.

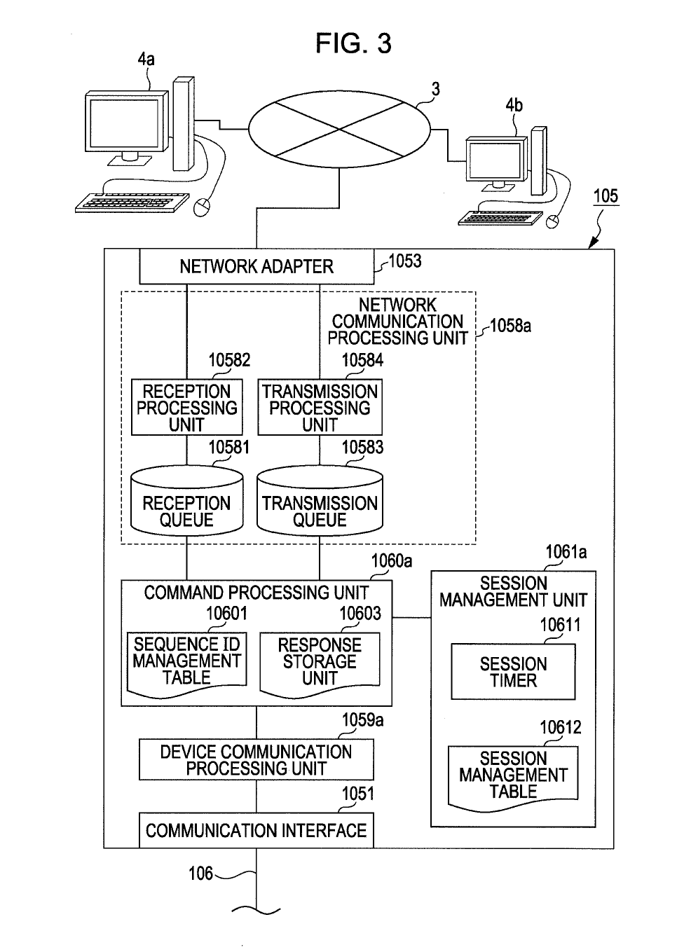

The CPU 1054 functions as various processing units illustrated in the function block diagram of FIG. 3 by processing these programs.

For example, by executing the network communication processing program 1058, the CPU 1054 functions as a network communication processing unit 1058a configured to control the network adapter 1053 and perform a communication with the supervisor terminal 4a or 4b via the network 3 for the supervisor.

Also, by executing the device communication processing program 1059, the CPU 1054 functions as a device communication processing unit 1059a configured to control the communication interface 1051 and perform a communication with the respective devices in the server rack 11 of FIG. 1 via the I2C 106.

The network communication processing unit 1058a has a reception queue 10581, a reception processing unit 10582, a transmission queue 10583, and a transmission processing unit 10584.

The reception processing unit 10582 accumulates the request 10590 from the network 3 for the supervisor which has been received by the network adapter 1053 in the reception queue 10581. Also, the transmission processing unit 10584 controls the network adapter 1053 and transmits a response 10591 accumulated in the transmission queue 10583 to the supervisor terminal 4a or 4b. The reception queue 10581 and the transmission queue 10583 both perform an input and an output of data on the basis of a FIFO (First-In First-Out) system.

Furthermore, the CPU 1054 functions as a command processing unit 1060a by executing the command processing program 1060. The command processing unit 1060a takes out the request 10590 from the reception queue 10581 of the network communication processing unit 1058a, controls the device communication processing unit 1059a, and transmits a request (instruction) to a device in the server rack 11 corresponding to the taken request 10590. Also, the command processing unit 1060a performs a control for transmitting various information received via the I2C 106 by the communication interface 1051 to the network communication processing unit 1058a.

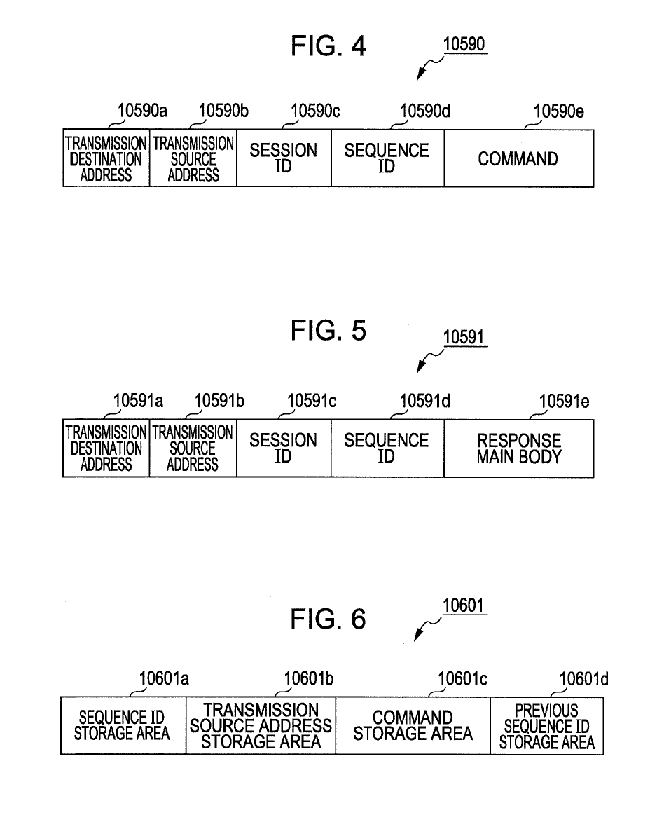

An example of a request transmitted to the server management apparatus 105 by the supervisor terminal 4a or 4b will be described by using FIG. 4. The request 10590 transmitted from the supervisor terminal 4a or 4b includes a transmission destination address 10590a. The transmission destination address 10590a is a network address of the network adapter 1053 of the server management apparatus 105 that is the transmission destination. Also, the request 10590 includes a transmission source address 10590b. The transmission source address 10590b is a network address of the supervisor terminal 4a or 4b that is the transmission source. Furthermore, the request 10590 includes a session ID 10590c of a session established between the supervisor terminal 4a or 4b and the server management apparatus 105. Also, the request 10590 includes a sequence ID 10590d uniquely assigned for each request 10590 by the supervisor terminal 4a or 4b and information on the command 10590e. In this manner, the supervisor terminal 4a or 4b assigns the unique sequence ID 10590d each time the request 10590 is carried out to be transmitted to the server management apparatus 105. It is noted that when the request 10590 is received by the network adapter 1053 of the server management apparatus 105, the reception processing unit 10582 stores the request 10590 in the reception queue 10581.

It is noted that the session ID 10590c is used for establishing a communication between the supervisor terminal 4a or 4b and the server management apparatus 105. Therefore, in a case where the network address 10590a at the transmission destination and the network address 10590b at the transmission source are different from each other, the session IDs 10590 are different from each other.

Next, an example of a response transmitted by the server management apparatus 105 to the supervisor terminal 4a or 4b will be described by using FIG. 5.

The response 10591 transmitted by the server management apparatus 105 to the supervisor terminal 4a or 4b includes a transmission destination address 10591a. The transmission destination address 10591a is a network address of the supervisor terminal 4a or 4b that is the transmission destination. Also, the response 10591 includes a transmission source address 10591b. The transmission source address 10591b is a network address of the network adapter 1053 of the server management apparatus 105 that is the transmission source. Furthermore, the response 10591 includes a session ID 10591c of the session established between the supervisor terminal 4a or 4b and the server management apparatus 105. Also, the response 10591 includes a sequence ID 10591d uniquely assigned for each request by the supervisor terminal 4a or 4b and information on a response main body 10591e. The sequence ID 10591d corresponds to the sequence ID 10590d included in the request 10590 from the supervisor terminal 4a or 4b. That is, in the supervisor terminal 4a or 4b, by checking the sequence ID 10591d, it is possible to check to which request 10590 the response 10591 corresponds.

Also, the response 10591 is generated on the basis of the information on the various sensors collected from the respective devices in the server rack 11 by the command processing unit 1060a and stored in the transmission queue 10583. Then, the transmission processing unit 10584 takes out the response 10591 stored in the transmission queue 10583 and controls the network adapter 1053 to be sent to the supervisor terminal 4a or 4b that has transmitted the request 10590.

Also, the command processing unit 1060a has a sequence ID management table 10601 for managing the sequence ID 10590d of the obtained request 10590. As illustrated in FIG. 6, the sequence ID management table 10601 has storage areas 10601a and 10601b that store the sequence ID 10590d included in the request 10590 that is obtained from the reception queue 10581 and the transmission source address 10590b while being associated with each other. (Hereinafter, a description will be given while the storage area 10601a is set as a sequence ID storage area 10601a and the storage area 10601b is set as a transmission source address storage area 10601b.) Also, the sequence ID management table 10601 has a command storage area 10601c where a command 10590e of the obtained request is stored. Furthermore, the sequence ID management table 10601 has a previous sequence ID storage area 10601d. Also, the command processing unit 1060a has a response storage unit 10603 that stores responses 10801 from the respective devices.

Furthermore, by executing the session management program 1061, the CPU 1054 functions as a session management unit 1061a. The session management unit 1061a manages the session with respect to the supervisor terminal 4a or 4b. As illustrated in FIG. 3, the session management unit 1061a has a session timer 10611 and a session management table 10612.

When a request 10602 from the command processing unit 1060a exists, the session management unit 1061a resets the session timer 10611 and also performs processing of releasing the session (session time out processing) if a value of the session timer 10611 passes 20 minutes. Detailed processing of the session management unit 1061a will be described below.

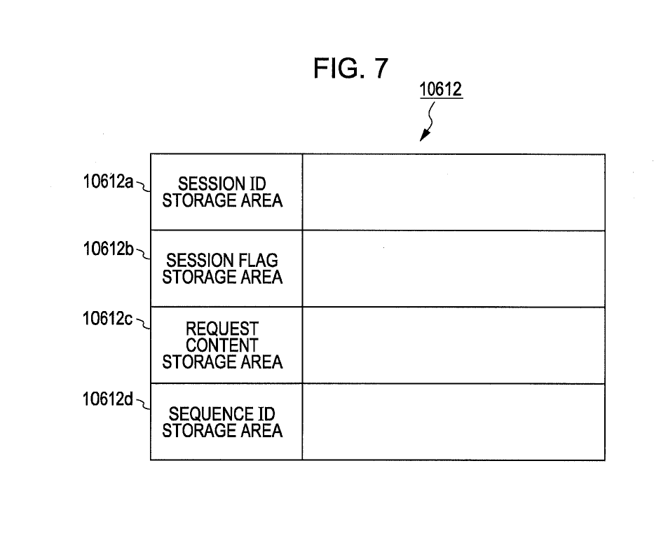

Also, as illustrated in FIG. 7, the session management table 10612 has a session ID storage area 10612a, a session flag storage area 10612b, a request content storage area 10612c, and a sequence ID storage area 10612d.

The session ID storage area 10612a is an area where an session ID of the established session is stored. Also, the session flag storage area 10612b is an area where a flag for determining whether or not the session is established is stored. According to the present embodiment, when the flag stored in the session flag storage area 10612b is “1”, it is indicated that the session is established, and when the flag is “0”, it is indicated that the session is not yet established. The session management unit 1061a generates a session ID at the time of a session start to be stored in the session ID storage area 10612a and also updates the value stored in the session flag storage area 10612b to “1”. Also, in a case where the request 10602 of the session time out processing or the session end from the command processing unit is received, the session management unit 1061a deletes the session ID of the session ID storage area 10612a. Then, the session management unit 1061a updates the value stored in the session flag storage area 10612b to “0”.

The request content storage area 10612c is an area where the request 10602 received from the command processing unit 1060a is stored. Also, the sequence ID storage area 10612d is an area where a unique ID (sequence ID) assigned to each request is stored.

Next, the supervisor terminal 4a that is an upper-level apparatus according to the present embodiment will be described. It is noted that since the supervisor terminal 4a and 4b according to the present embodiment have the same configuration, the supervisor terminal 4b also has the component requisite of the supervisor terminal 4a that will be described below.

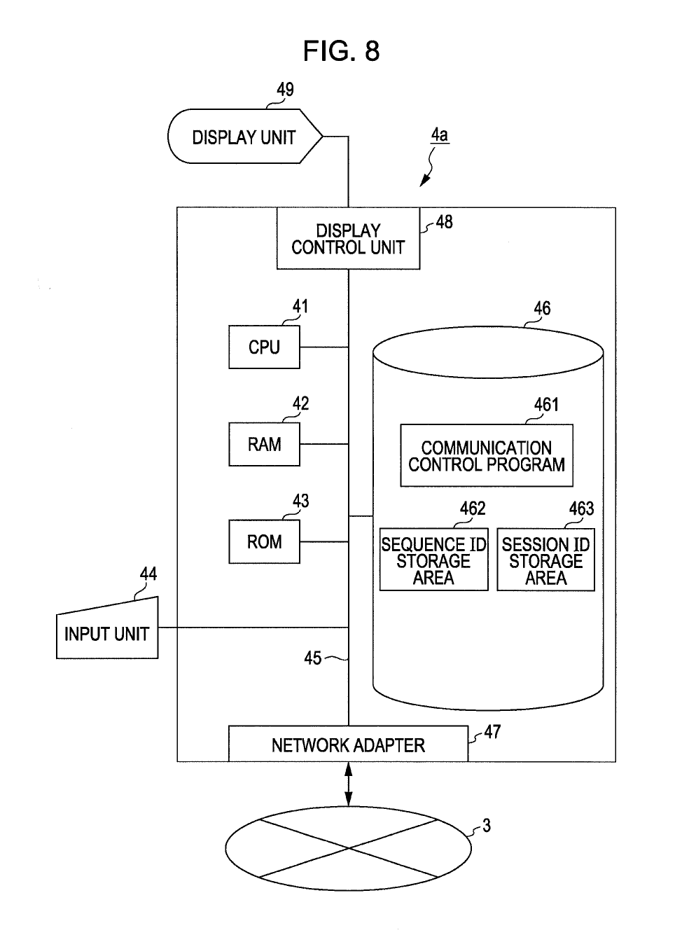

FIG. 8 is a hardware conceptual diagram of the supervisor terminal 4a.

As illustrated in FIG. 8, the supervisor terminal 4a has a CPU 41, a RAM 42, a ROM 43, an input unit 44 such as a key board, a hard disc apparatus 46, a network adapter 47, and a display control unit 48 configured to perform a display control on a display unit 49, and the respective components are connected by an internal bus 45.

Among these, the network adapter 47 is connected to the network 3 for the supervisor and performs a communication with the server management apparatus 105 via the network 3 for the supervisor.

The CPU 41 executes a communication control program 461 stored in the hard disc apparatus 46. Also, along with the execution of the communication control program 461 stored in the hard disc apparatus 46, the CPU 41 appropriately performs an access to the data in the hard disc apparatus 46, a write and readout of the data with respect to the RAM 42, and a readout of the data from the ROM 43. Furthermore, along with the execution of these programs, the CPU 41 appropriately performs a display control of the display unit 49 by the display control unit 48 and a communication control of the network adapter 47.

Also, the hard disc apparatus 46 has a sequence ID storage area 462 where a session ID is stored and a session ID storage area 463 where a sequence ID is stored.

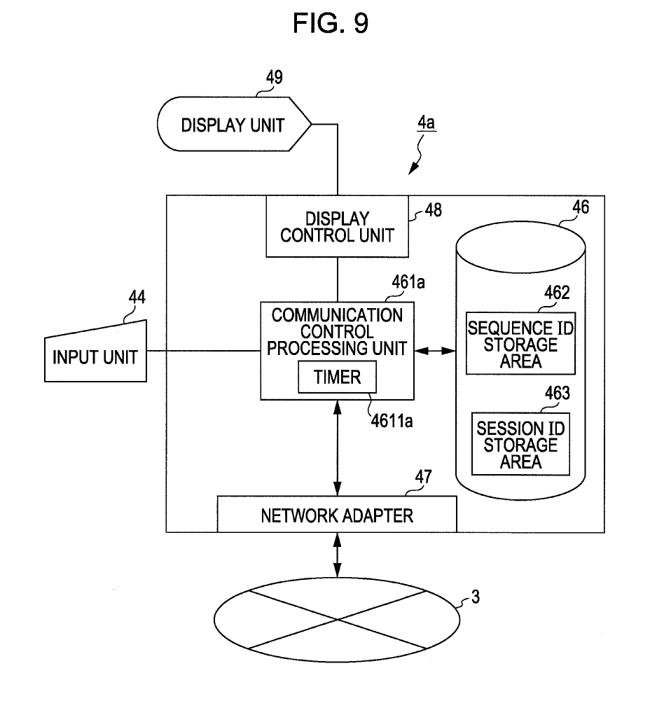

Also, by processing the communication control program 461, the CPU 41 functions as a communication control processing unit 461a illustrated in the function block diagram of FIG. 9. The communication control processing unit 461a has a timer 4611a.

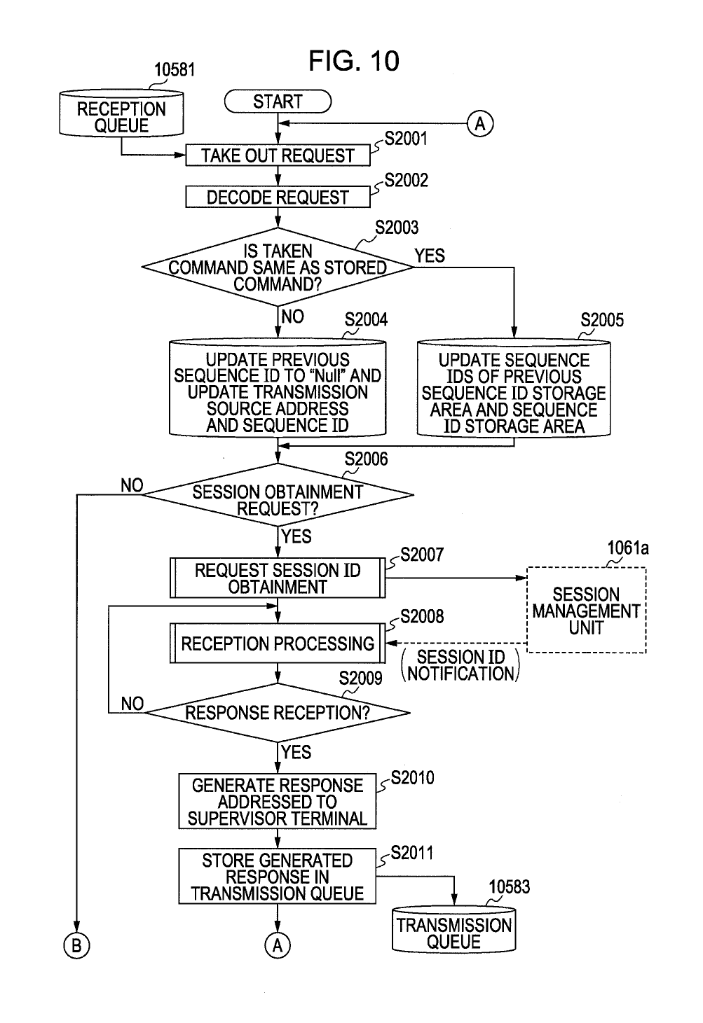

Next, processing by the command processing unit 1060a described above will be described by using flow charts of FIG. 10 and subsequent figures.

In the flow chart of FIG. 10, first, the command processing unit 1060a takes out the request 10590 received from the supervisor terminal 4a or 4b from the reception queue 10581 (S2001). Then, the command processing unit decodes a content of the command 10590e of the taken request 10590 (S2002).

Then, the command processing unit 1060a compares a command stored in a command storage area 10601e of the sequence ID management table 10601 with the command 10590e of the request 10590 taken out from the reception queue 10581 (S2003).

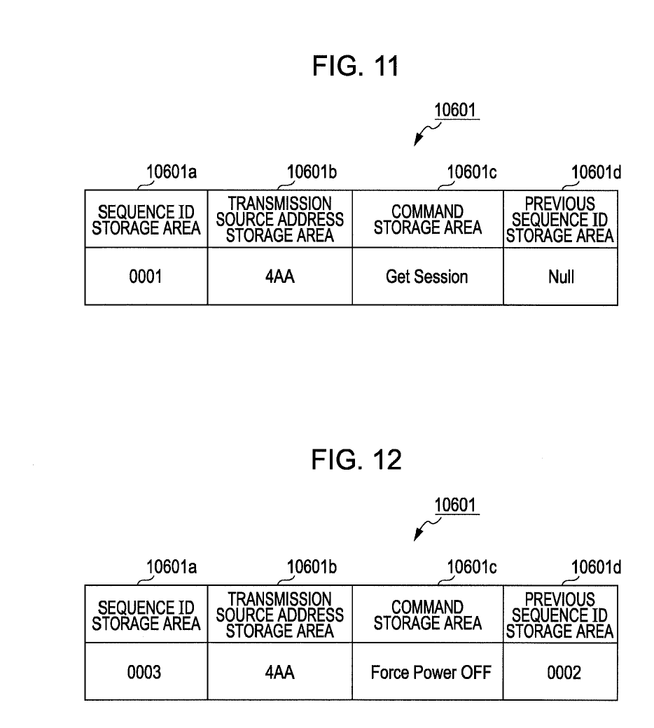

In a case where it is determined that the commands are different from each other in the processing in S2003, the command processing unit 1060a updates the information on the previous sequence ID storage area 10601d of the sequence ID management table 10601 to “Null” which indicates undefined. Also, the command processing unit 1060a updates the value of the sequence ID storage area 10601a to the value of the sequence ID included in the decoded request 10590. Similarly, the command processing unit 1060a updates the value of the transmission source address storage area 10601b to the value of the transmission source address 10590b included in the decoded request 10590. Furthermore, the command processing unit 1060a updates the value of the command storage area 10601c to the value of the command 10590e included in the decoded request 10590 (S2004). The example of the processing result in S2004 is illustrated in FIG. 11.

Next, a case in which it is determined in the processing in S2003 that the commands are the same will be described. First, the command processing unit 1060a updates the sequence ID stored in the previous sequence ID storage area 10601d of the sequence ID management table 10601 to the value of the sequence ID stored in the sequence ID storage area 10601a. Also, the command processing unit 1060a updates the value of the sequence ID storage area 10601a to the value of the sequence ID 10590d included in the request 10590 decoded in the processing in S2002. Similarly, the command processing unit 1060a updates the value of the transmission source address storage area 10601b to the value of the transmission source address 10590b included in the request 10590 decoded in the processing in S2002. Furthermore, the command processing unit 1060a updates the value of the command storage area 10601c in the processing in S2002 to the value of the command 10590e included in the decoded request 10590 (S2005). The example of the processing result in S2005 is illustrated in FIG. 12.

According to the present embodiment, by carrying out the processing in the above-mentioned manner, the command processing unit 1060a can determine whether or not the request 10590 having the same content as the previous content is received by determining whether or not the previous sequence ID storage area 10601d of the sequence ID management table 10601 is “Null”. Furthermore, in a case where the request 10590 having the same content as the previous content is transmitted, the sequence ID 10590d of the current request 10590 is stored in the sequence ID storage area 10601a and the previous sequence ID is stored in the previous sequence ID storage area 10601d.

It is noted that according to the present embodiment, the description will be given while the addresses of the supervisor terminals 4a and 4b are respectively set as “4AA” and “4BB” and the address of the network 3 for the supervisor of the server management apparatus 105 is set as “555”. (For example, in the case of the request 10590 illustrated in FIG. 11, since the value of the transmission source address 10590b is “4AA”, the request 10590 indicates that the supervisor terminal 4a is the transmission source.)

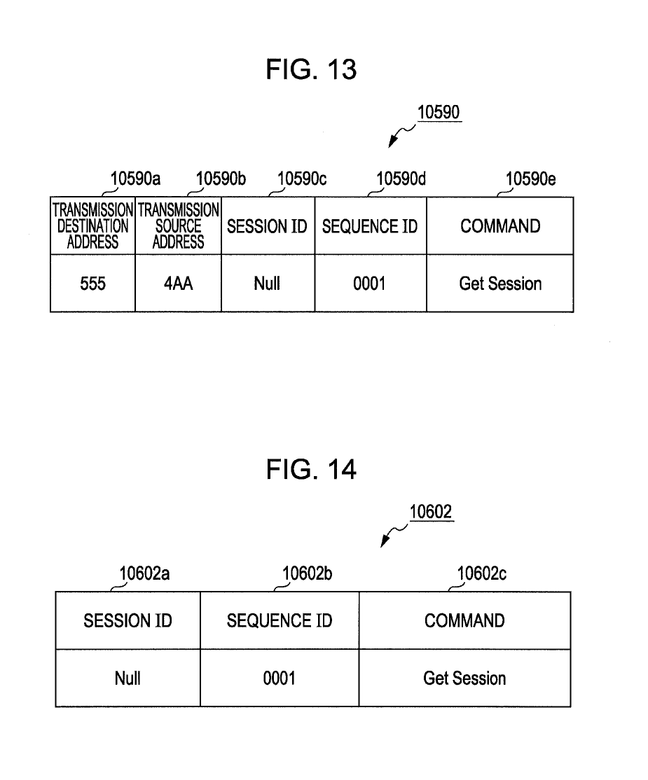

At this time, the command processing unit 1060a checks whether or not “Get Session” indicating the request 10590 for the session ID obtainment is stored in the command 10590e of the request 10590 decoded in the processing in S2002 (S2006). At this time, in a case where “Get Session” is stored, the command processing unit 1060a transmits the session obtainment request to the session management unit 1061a (S2007). (It is noted that since the request 10590 for the session ID obtainment is the obtainment request of the session ID, at this time point, the session ID is undefined. Therefore, as illustrated in FIG. 13, the value of the session ID 10590c of the request 10590 is “Null” which indicates undefined.)

As illustrated in FIG. 14, the command processing unit 1060a that has received the request 10590 extracts the session ID 10590c, the sequence ID 10590d, and the command 10590e from the request 10590 obtained from a reception queue 10591 and generates the request 10602 in which a session ID 10602a, a sequence ID 10602b, and a command 10602c are respectively set. Then, by transmitting the generated request 10602 to the session management unit 1061a, the command processing unit 1060a performs the obtainment request of the session (S2007).

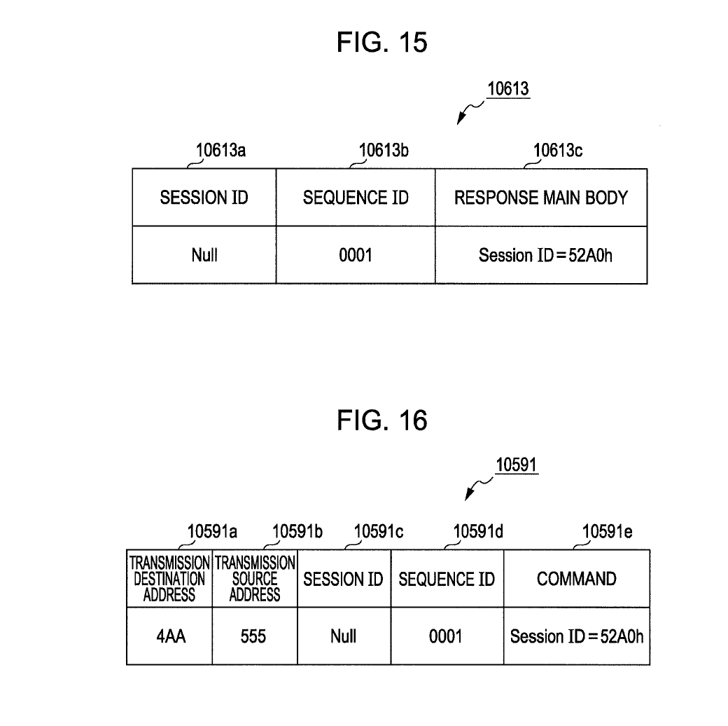

After that, the command processing unit 1060a receives a response 10613 corresponding to the session ID obtainment request from the session management unit 1061a (S2008, S2009). As illustrated in FIG. 15, the response 10613 includes a session ID 10613a, a sequence ID 10613b, and a response main body 10613c.

Then, the command processing unit 1060a refers to the sequence ID management table 10601 and extracts a transmission source address corresponding to “0001” that is the value of the sequence ID 10613b included in the response 10613. As described above, according to the present embodiment, in the sequence ID management table 10601, the value “0001” of the sequence ID 10613b and “4AA” of the transmission source address storage area 10601b are stored while being associated with each other, and among these, the value “4AA” of the transmission source address storage area 10601b is extracted.

Then, as illustrated in FIG. 16, the command processing unit 1060a adds the extracted value “4AA” of the transmission source address storage area 10601b to the response 10613 obtained from the session management unit 1061a as the transmission destination address 10591a. Furthermore, the command processing unit 1060a adds an address “555” of the server management apparatus 105 to the response 10613 as the transmission source address 10591b to generate the response 10591 addressed to the supervisor terminal 4a (S2010).

Then, the command processing unit 1060a stores the generated response 10591 in the transmission queue 10583 (S2011), and the flow shifts to the processing in S2001.

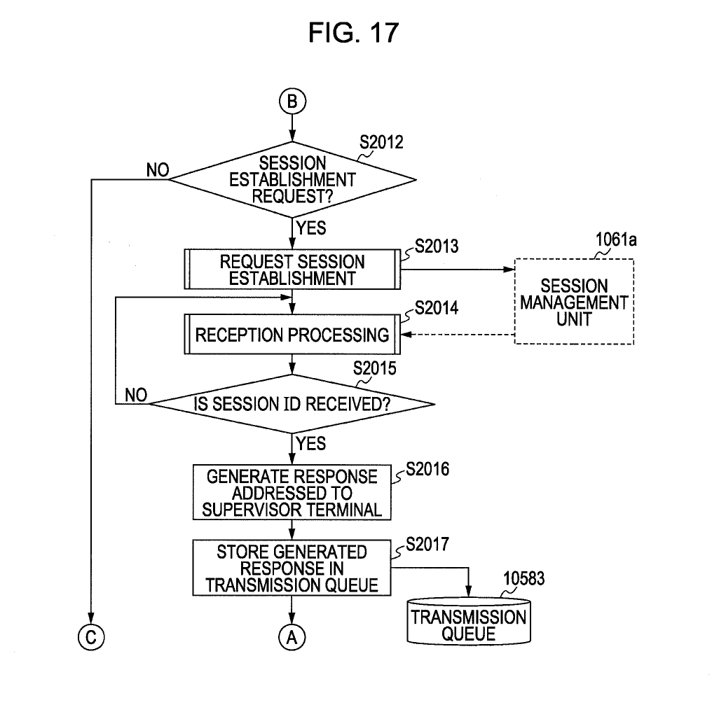

Next, in the processing in S2006, in a case where it is determined that the decoded request 10590 is not the session obtainment request, the command processing unit 1060a determines whether or not the request 10590 is the request 10590 for the session establishment (FIG. 17: S2012).

In the processing in S2012, when it is determined that the request 10590 is the session establishment request, the command processing unit 1060a performs the session establishment request to the session management unit 1061a (S2013). It is noted that the request 10590 for the session establishment is a request indicating a command for starting the session based on the obtained session ID by the supervisor terminal 4a or 4b that obtains the session ID.

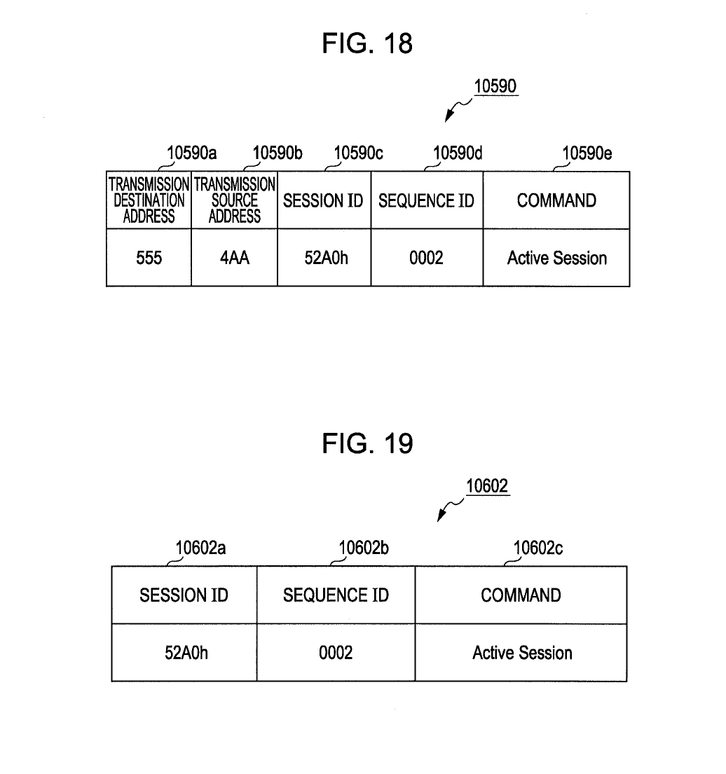

An example of this session establishment request will be illustrated in FIG. 18. As illustrated in FIG. 18, the request 10590 for the session establishment is the request 10590 including “Active Session” indicating the session establishment in the command 10590e. As described above, since the request 10590 for the session establishment is a request transmitted by the supervisor terminal 4a or 4b that obtains the session ID, the value of the session ID 10590c included in the request 10590 is not “Null” which indicates undefined but is a value “52A0h”.

Also, an additional description will be made on the session establishment request transmitted from the command processing unit 1060a to the session management unit 1061a. As illustrated in FIG. 19, the session establishment request is carried out by transmitting the request 10602 that is generated by extracting the session ID, the sequence ID, and the command from the request 10590 to the session management unit 1061a.

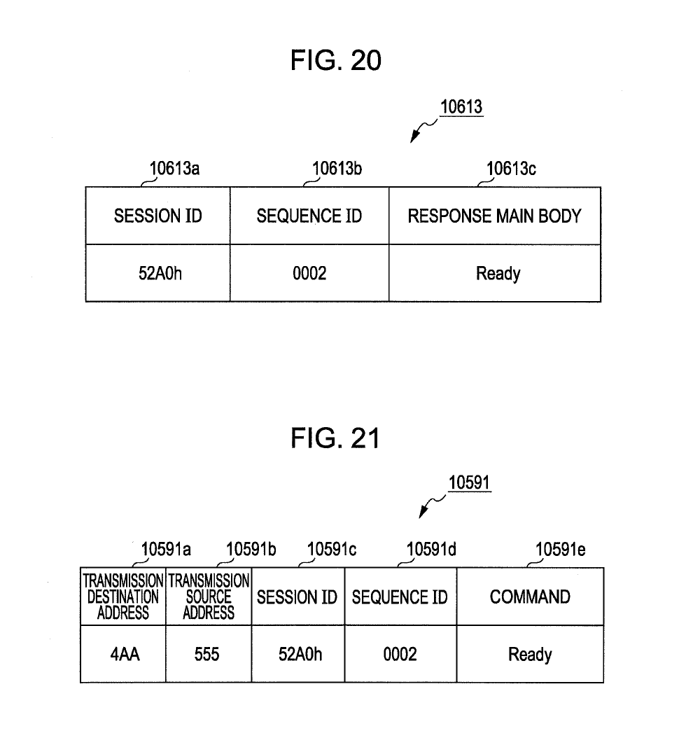

After that, the response 10613 corresponding to this obtainment request is received from the session management unit 1061a (S2014, S2015). As illustrated in FIG. 20, the response 10613 includes the session ID 10613a, the sequence ID 10613b, and the response main body 10613c.

Next, by carrying out processing similar to S2010 described above, the command processing unit 1060a generates the response 10591 addressed to the supervisor terminal 4a illustrated in FIG. 21 (S2016).

Then, the command processing unit 1060a stores the generated response 10591 in the transmission queue 10583 (S2017), and the flow shifts to the processing in S2001 of FIG. 10.

It is noted that “Ready” included in the response main bodies 10613c and 10591e of the responses 10613 and 10591 illustrated in FIG. 20 and FIG. 21 is information indicating a permission for each session establishment.

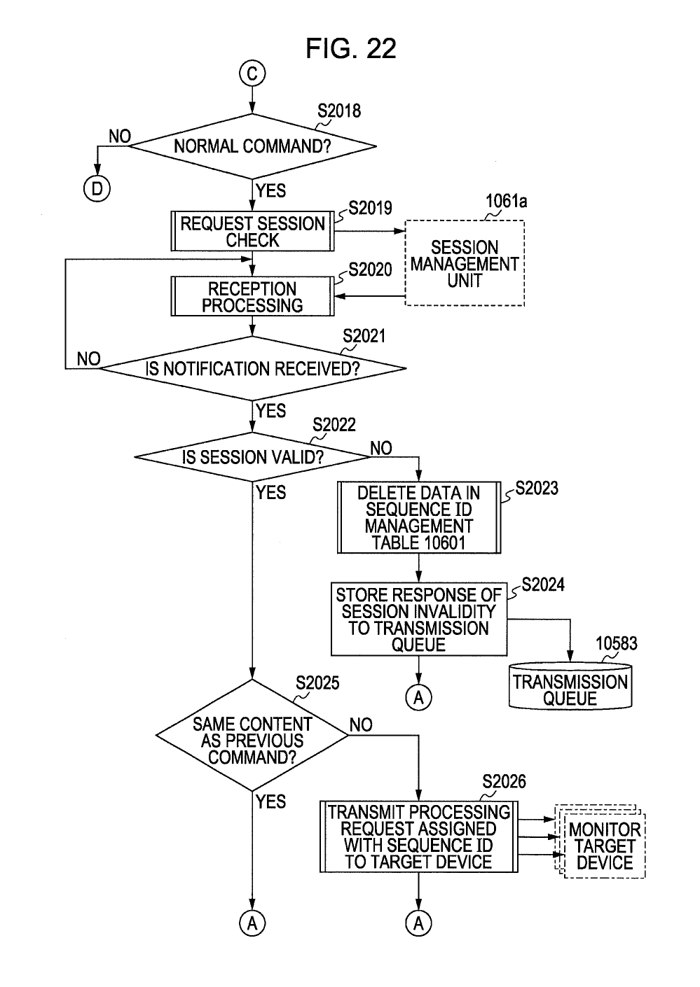

Next, in the processing in S2012, in a case where it is determined that the decoded request 10590 does not indicate the session establishment, the command processing unit 1060a determines whether or not the request is the normal request 10590 (FIG. 22: S2018).

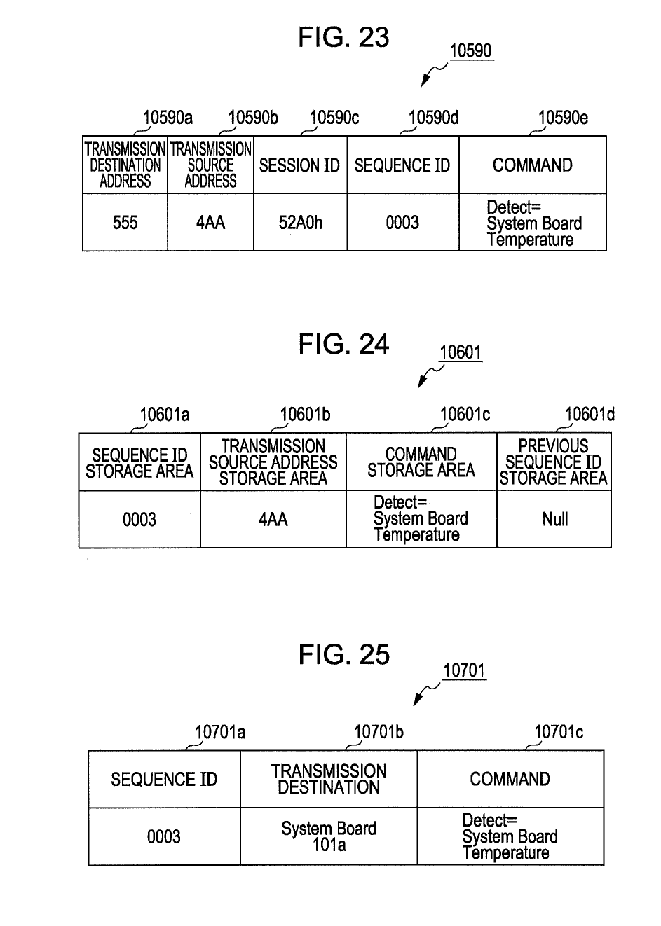

It is noted that according to the present embodiment, the normal request 10590 indicates that a request other than a request related to the session such as obtainment, establishment, release, and the like of the session ID is prescribed as normal session. Also, a description will be given below while a case is taken as an example in which as illustrated in FIG. 23, “Detect=System Board Temperature” meaning a command for a temperature detection of the CPUs 1014a to 1014n of the system boards 101a to 101n which is a type of the normal command is included in the command 10590e.

As a result of the decoding processing in S2002, in a case where it is determined that the normal command is included like the request 10590 illustrated in FIG. 23 (S2018), a command processing unit 2060a transmits the request 10602 of the session check to the session management unit 1061a (S2019).

After that, when the response 10613 is received from the session management unit 1061a (S2020, S2021), the command processing unit 1060a checks whether or not the response 10591 indicates that the session is valid (S2022). In the processing in S2023, in a case where the response 10591 indicates that the session is valid, the command processing unit 2060a refers to the sequence ID management table 10601 and checks whether or not the command is the same as the command in the previous request 10590 (S2025). In the processing in S2003 to S2005 of FIG. 10, the command is the same as the previous command, a command processing unit 2061a stores the previous sequence ID in the previous sequence ID storage area 10601d of the sequence ID management table 10601. Also, when the command is not the same as the previous command, the command processing unit 2061a stores “Null” in the previous sequence ID storage area 10601d of the sequence ID management table 10601. Therefore, in the processing in S2025, in a case where the sequence ID is stored in the previous sequence ID storage area 10601d, the command processing unit 1060a determines that the command is the same as the previous command, and in a case where “Null” is stored, determines that the command is a command different from the previous command.

In the processing in S2025, in a case where the command processing unit 2060a determines that the command is a command different from the previous command, the command processing unit 2060a controls the communication interface 1051 and transmits a processing request 10701 via the I2C 106 to a target device (S2026), and the flow shifts to the processing in S2001 of FIG. 10. An example of the processing request 10701 transmitted to the target device in the processing in S2026 is illustrated in FIG. 25. FIG. 25 illustrates the processing request 10701 to a system board 101a corresponding to the request 10590 from the supervisor terminal 4a illustrated in FIG. 23.

The processing request 10701 to the target device includes a sequence ID 10701a included in the request 10590 from the supervisor terminal 4a, a transmission destination 10701b (in this case, the system board 101a), and a command 10701c included in the request 10590 from the supervisor terminal 4a.

It is noted that in the above, only the system board 101a has been described, but the command processing unit 1060a also transmits a similar request 10701 to other target system boards 101b to 101n. Then, in response to the request 10701, the respective system boards 101b to 101n perform similar processing to the system board 101a and a transmission of the response 10801.

Also, in the processing in S2025, in a case where it is determined that the same command as the command included in the previous request 10590 is transmitted, the processing in S2026 is not carried out, and the flow shifts to the processing in S2001.

Furthermore, in the processing in S2022, in a case where the response 10613 from the session management unit 1061a indicates that the session is invalid, the data in the sequence ID management table 10601 is deleted (S2023). Then, the response 10591 indicating that the session is invalid is stored in the transmission queue 10583 (S2024), and the flow shifts to the processing in S2001.

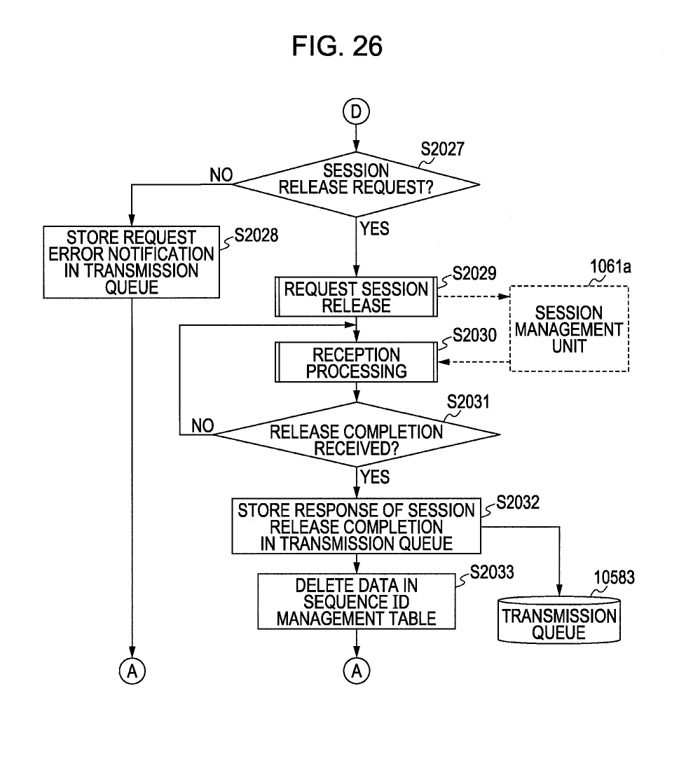

Also, in S2018, when it is determined that the request 10590 taken out from the reception queue 10581 does not include the normal command, the command processing unit 2060a determines whether or not the request is the request 10590 for the session release (FIG. 26: S2027).

At this time, in a case where it is determined that the request is not the session release request, the command processing unit 1060a generates a request error notification to the supervisor terminal 4a or 4b that has transmitted the request 10590 to be stored in the transmission queue 10583 (S2028), and the flow shifts to the processing in S2001.

Also, when it is determined in S2027 that the request is the session release request, the command processing unit 1060a performs the session release request to the session management unit 1061a (S2029).

After that, when the response 10613 of the session release completion is received from the session management unit 1061a (S2030, S2031), the response 10591 indicating that the session release is completed is stored in the transmission queue 10583 (S2032). Then, the command processing unit 1060a deletes the data in the sequence ID management table 10601 (S2033), and the flow shifts to the processing in S2001.

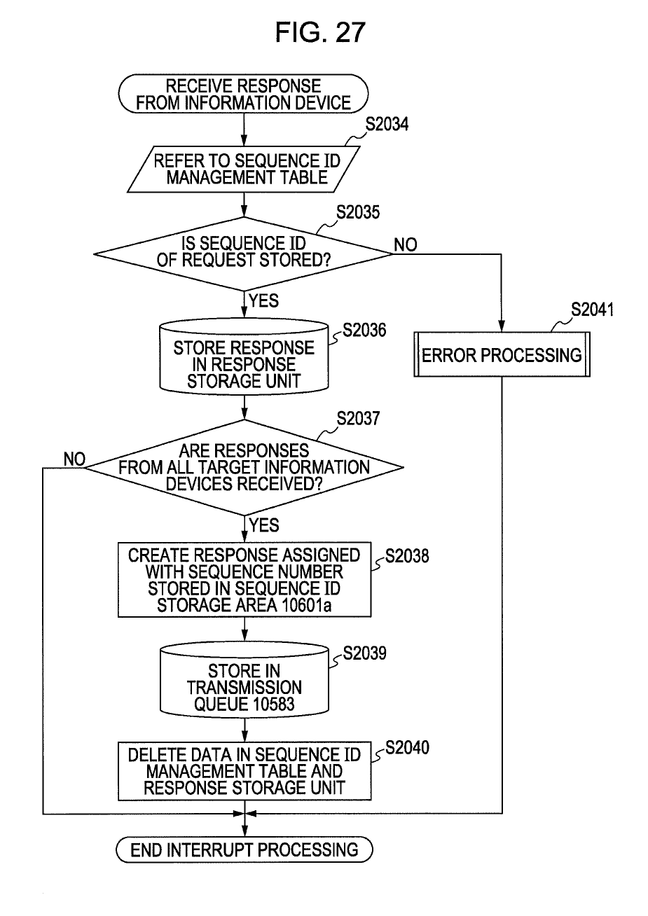

Next, in the processing in S2026 of FIG. 22, a case in which after a processing request is transmitted to the respective devices that become the processing targets, the responses 10801 corresponding to this processing request from the respective devices are received will be described while taking a flow chart of FIG. 27 as an example.

It is noted that according to the present embodiment, the description will be given while taking as an example a case in which the processing request illustrated in FIG. 25 is transmitted which is exemplified in the above-mentioned processing.

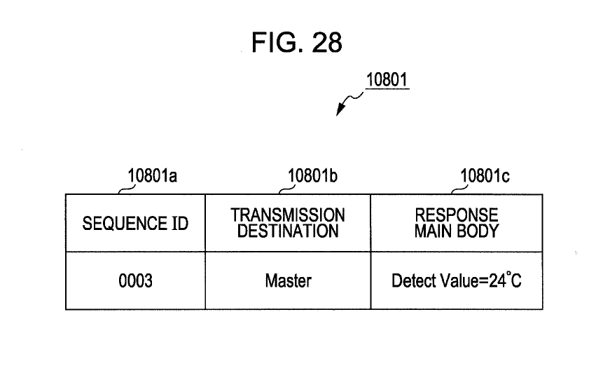

A communication interface 1012a of the system board 101a receives this processing request via the I2C 106. Then, the communication interface 1012a obtains temperature information from temperature sensor 1011a and transmits the response 10801 including the obtained temperature information via the I2C 106 to the server management apparatus 105. An example of the response 10801 is illustrated in FIG. 28. As illustrated in FIG. 28, a sequence ID 10801a in the processing request 10701, a transmission destination 10801b, and a response main body 10801c for storing the obtained temperature information are included.

When the communication interface 1051 receives the response 10801 described above from one of the devices, the communication interface 1051 performs an interrupt instruction to the command processing unit 1060a. Along with this interrupt, the processing illustrated in FIG. 27 is executed.

First, the command processing unit 1060a determines whether or not a value of the sequence ID 10801a of the response 10801 is stored in the sequence ID storage area 10601a of the sequence ID management table 10601 or the previous sequence ID storage area 10601d (S2034, S2035).

At this time, in a case where it is determined that the value is stored in one of the storage areas, the command processing unit 1060a stores the received response 10801 in the response storage unit 10603 (S2036). Then, the command processing unit 1060a checks whether or not the responses 10801 from the respective devices which are accumulated in the response storage unit 10603 and the responses 10801 from the target devices corresponding to the request 10590 are all received (S2037).

If the responses 10801 from all the target devices are not received, the command processing unit 2060a ends the interrupt processing.

Also, if the responses 10801 from all the target devices are received, the command processing unit 2060a creates the response 10591 assigned with the sequence number stored in the sequence ID storage area 10601a in the sequence ID management table 10601 (S2038). Then, the command processing unit 1060a stores the created response 10591 in the transmission queue 10583 (S2039) and deletes the data in the sequence ID management table 10601 and the response storage unit 10603 (S2040) to end the interrupt processing.

It is noted that in the processing in S2035, in a case where it is determined that the sequence ID of the request is not stored, the command processing unit 2060a performs error processing of invalidating the received response 10591 or the like (S2041) and completes the interrupt processing.

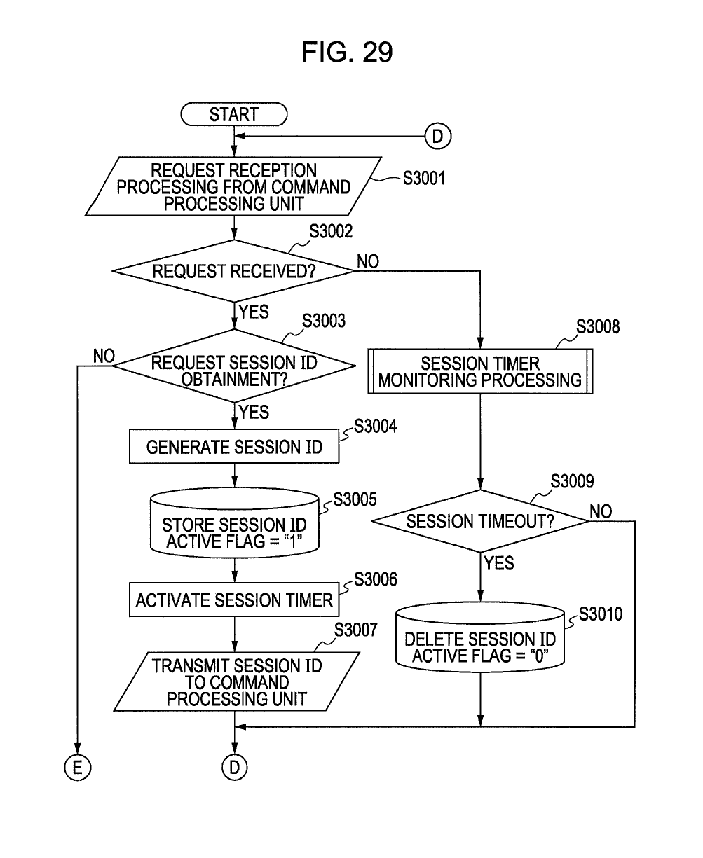

Next, processing by the session management unit 1061a will be described by using a flow chart of FIG. 29.

The session management unit 1061a performs request reception processing from the command processing unit 1060a (S3001) and determines whether or not the request 10602 from the command processing unit 1060a is received (S3002).

At this time, in a case where the request 10602 is received, the session management unit 1061a checks whether or not the received request 10602 is the request 10602 indicating the session ID obtainment request (S3003).

At this time, in a case where the received request 10602 is the session ID obtainment request, the session management unit 1061a generates a unique session ID (S3004). Then, the session management unit 1061a stores the session ID in the session management table 10612 and also updates the value of the session flag storage area 10612b to “1” (S3005). In addition, the session management unit 1061a activates the session timer 10611 and starts time count (S3006).

Then, the session management unit 1061a transmits the response 10613 including the session ID to the command processing unit 1060a (S3007). In the command processing unit 1060a, the response 10613 is the response described in FIG. 15.

Then, the session management unit 1061a shifts to the processing in S3001.

Also, in the processing in S3002, in a case where the request 10602 from the command processing unit 1060a is not received, the session management unit 1061a checks the value of the session timer 10611 (S3008). As a result of this check, in a case where it is determined that time out occurs (in the case according to the present embodiment, 20 minutes), the session management unit 1061a deletes the session ID stored in the session management table 10612 and updates the active flag to “0” (S3010) to shift to the processing in S3001. It is noted that in the processing in S3009, in a case where it is determined that time out does not occur, the session management unit 1061a does not performs the processing in S3010 and shifts to the processing in S3001.

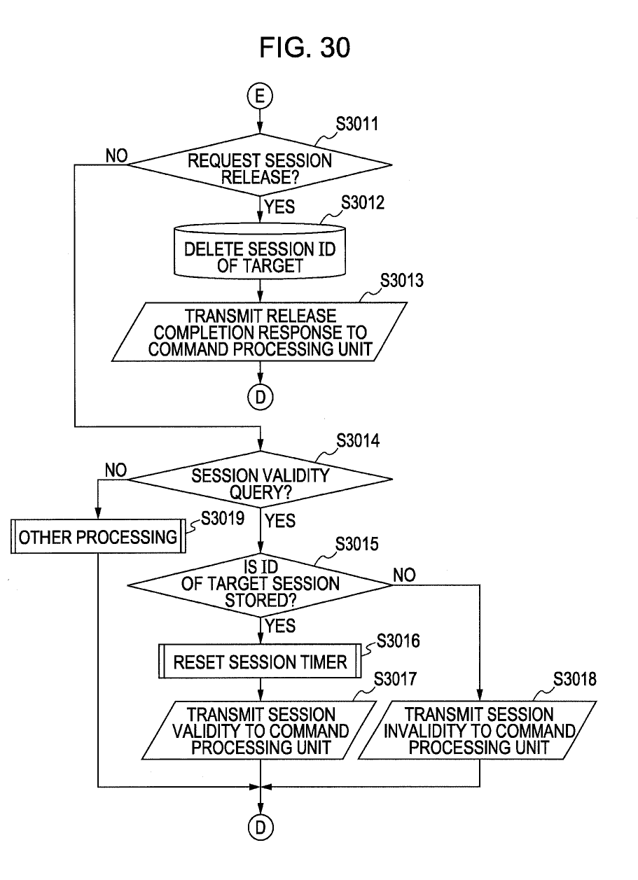

In the processing in S3003, in a case where it is determined that the request 10602 from the command processing unit 1060a is not the session ID obtainment request, the session management unit 1061a determines whether or not is the session release request (FIG. 30: S3011).

Then, in a case where it is determined that the request is the session release request, the session management unit 1061a deletes the data such as the session ID from the session management table 10612 (S3012).

Then, the session management unit 1061a transmits the response 10613 indicating that the session is released to the command processing unit 1060a (S3013), and the flow shifts to the processing in S3001.

Furthermore, in the processing in S3011, when it is determined that the request 10602 from the command processing unit 1060a is not the session release request, the session management unit 1061a determines whether or not the request 10602 is the request 10602 indicating a query on the session validity (S3014).

At this time, when it is determined that the request 10602 is the request 10602 of the query on the session validity, the session management unit 1061a checks whether or not the session ID is stored in the session management table 10612 (S3015). At this time, when it is determined that the session ID is stored in the session management table 10612, the session management unit 1061a resets the session timer 10611, that is, sets the value to “0” again (S3016). Then, the session management unit 1061a transmits the response 10613 indicating the validity of the session to the command processing unit 1060a (S3017), and the flow shifts to the processing in S3001. In the processing in S3015, when it is determined that the session ID is not stored, the session management unit 1061a transmits the response 10613 of the session invalidity to the command processing unit 1060a, and the flow shifts to the processing in S3001.

Furthermore, in the processing in S3014, in a case where it is determined that the request 10602 from the command processing unit 1060a is not the query on the session validity, that is, in a case where the request is other query, the session management unit 1061a performs the processing in accordance with the request 10602 (S3019) and shifts to the processing in S3001.

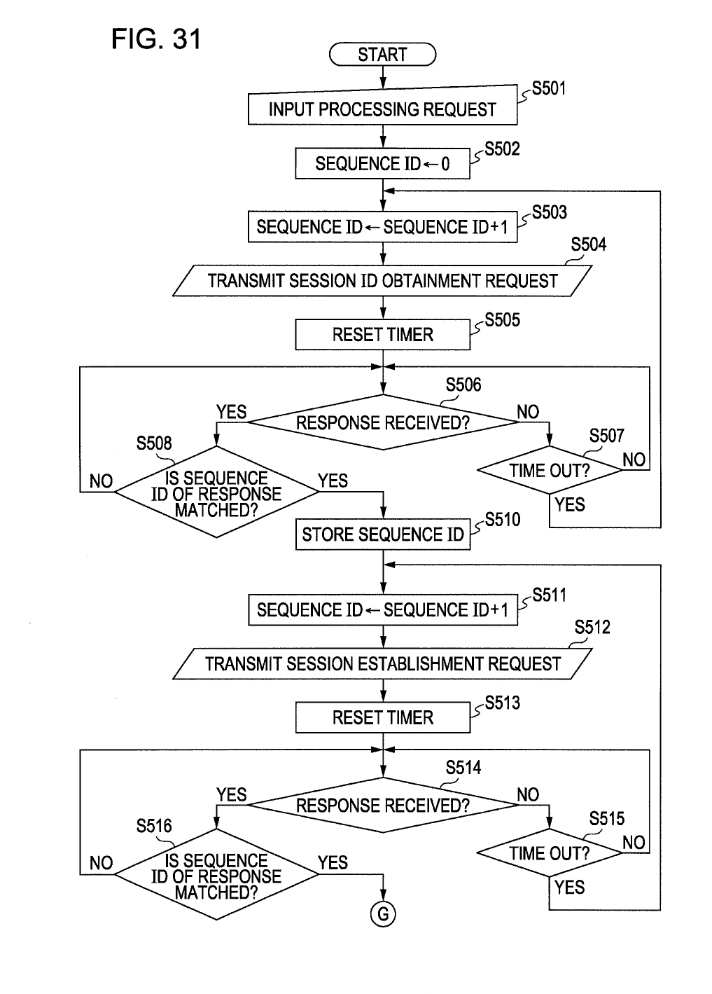

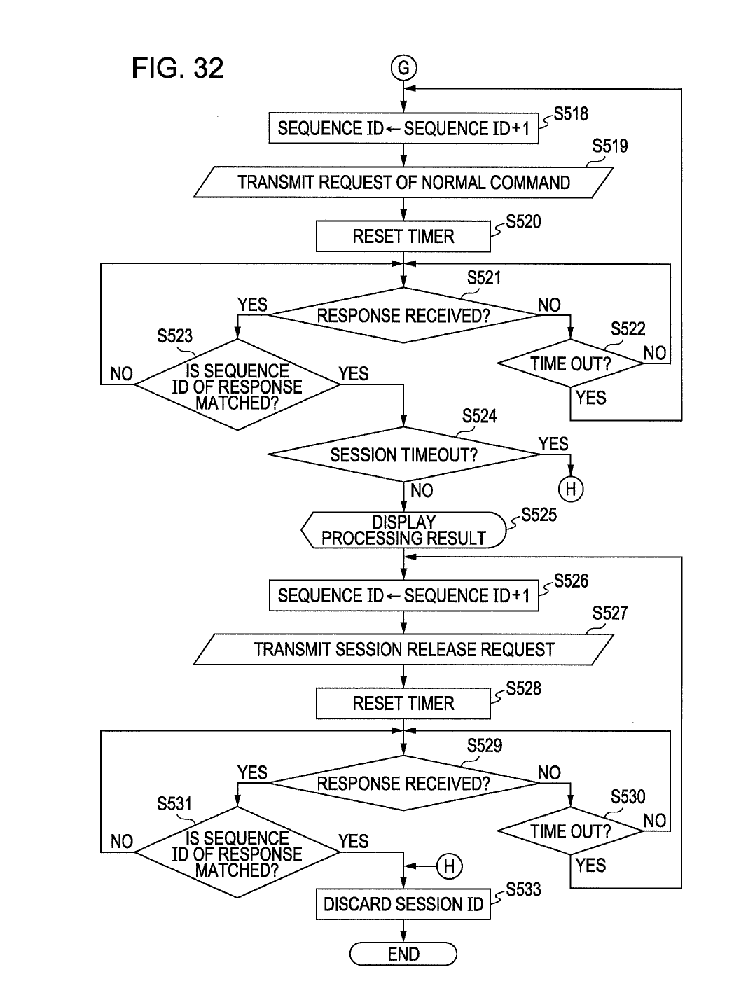

Next, processing by the communication control processing unit 461a of the supervisor terminal 4a will be described by using flow charts of FIG. 31 and FIG. 32.

First, when the supervisor inputs a processing request to the input unit 44 (S501), the communication control processing unit 461a updates the sequence ID stored in the sequence ID storage area 462 to “0” (S502).

Next, the communication control processing unit 461a adds “1” to the value of the sequence ID stored in the sequence ID storage area 462 for the update (S503). Then, the communication control processing unit 461a controls the network adapter 47 and transmits the request 10590 of the session ID obtainment request added with the sequence ID stored in the sequence ID storage area 462 to the server management apparatus 105 (S504). The request 10590 is the request 10590 illustrated in FIG. 13. In a case where the flow shifts from the processing in S502 to the processing in S503, since the sequence ID is “0”, through the processing in S503, the value of the sequence ID storage area 462 becomes “1”. Then, the communication control processing unit 461a resets the timer 4611a (S505).

After that, the communication control processing unit 461a checks whether or not the response 10591 is received via the network adapter 47 from the server network apparatus 105 (S506). In the processing in S506, in a case where the response 10591 is not received, the communication control processing unit 461a checks whether or not the value of the timer 4611a becomes larger than or equal to a predetermined period of time (whether or not time out occurs) (S507). According to the present embodiment, this predetermined period of time is set as 1 minute. That is, in the processing in S507 according to the present embodiment, the communication control processing unit 461a checks whether or not the timer 4611a indicates 1 minute or longer.

In the processing in S507, in a case where it is determined that time out does not occur, the communication control processing unit 461a shifts to the processing in S506. Also, in the processing in S507, in a case where it is determined that time out occurs, the communication control processing unit 461a shifts to the processing in S503.

As described above, since the processing in S503 is processing of adding one sequence ID, in a case where the processing is shifted from S507 to S503, with regard to the request 10590 of the session ID obtainment request in S504, the content itself of the command 10590e is the same “Get Session”, but the sequence ID of a value larger than the value of the previously transmitted sequence ID by “1” is assigned.

In the processing in S506, in a case where it is determined that the response 10591 is received from the server network apparatus 105, the communication control processing unit 461a checks the sequence ID 10591d included in the response 10591 (S508). This processing is executed with the aim of carrying out the processing while responses other than the response 10591 corresponding to the request 10590 transmitted in the last place are invalidated.

At this time, if the sequence ID 10591d included in the received response 10591 is different from the sequence ID stored in the sequence ID storage area 462, the communication control processing unit 461a shifts to the processing in S506.

Also, in the processing in S508, if the sequence ID 10591d included in the received response 10591 is the same as the sequence ID stored in the sequence ID storage area 462, the communication control processing unit 461a shifts to the processing in S510. That is, the communication control processing unit 461a stores the session ID 10591c included in the response 10591 in the session ID storage area 463.

Next, the communication control processing unit 461a adds “1” to the value of the sequence ID stored in the sequence ID storage area 462 for the update (S511). Then, the communication control processing unit 461a controls the network adapter 47 and transmits the request 10590 of the session ID establishment added with the sequence ID stored in the sequence ID storage area 462 and the session ID stored in the session ID storage area 463 to the server management apparatus 105 (S512). The request 10590 is the request 10590 illustrated in FIG. 18. Then, the communication control processing unit 461a resets the timer 4611a (S513).

After that, the communication control processing unit 461a checks whether or not the response 10591 is received via the network adapter 47 from the server network apparatus 105 (S514). In the processing in S514, in a case where the response 10591 is not received, the communication control processing unit 461a checks whether or not the value of the timer 4611a becomes larger than or equal to a predetermined period of time (whether or not time out occurs) (S515). According to the present embodiment, this predetermined period of time is set as 1 minute. That is, in the processing in S515 according to the present embodiment, the communication control processing unit 461a checks whether or not the timer 4611a indicates 1 minute or longer.

In the processing in S515, in a case where it is determined that time out does not occur, the communication control processing unit 461a shifts to the processing in S514. Also, in the processing in S515, in a case where it is determined that time out occurs, the communication control processing unit 461a shifts to the processing in S511.

Since the processing in S511 is processing of adding one sequence ID as described above, in a case where the processing is shifted from S515 to S511, with regard to the request 10590 of the session ID establishment in S512, the content itself of the command 10590e is the same “Active Session”, but the sequence ID having a value larger than the value of the transmitted sequence ID by “1”.

In the processing in S514, in a case where it is determined that the response 10591 is received from the server network apparatus 105, the communication control processing unit 461a checks the sequence ID included in the response 10591 (S516). This processing is executed with the aim of carrying out the processing while responses other than the response 10591 corresponding to the request 10590 transmitted in the last place are invalidated similarly as in the processing in S508.

At this time, if the sequence ID 10591d included in the received response 10591 is different from the sequence ID stored in the sequence ID storage area 462, the communication control processing unit 461a shifts to the processing in S514.

Also, in the processing in S516, when the sequence ID 10591d included in the received response 10591 is the same as the sequence ID stored in the sequence ID storage area 462, the communication control processing unit 461a shifts to the processing in S518 of FIG. 32. In the processing in S518, the communication control processing unit 461a adds “1” to the value of the sequence ID stored in the sequence ID storage area 462 for the update (S518). Then, the communication control processing unit 461a controls the network adapter 47 and adds the sequence ID stored in the sequence ID storage area 462 and the session ID stored in the session ID storage area 463 to transmit the request 10590 of the command (normal command) corresponding to the input of S501 to the server management apparatus 105 (S519). This request 10590 is the request 10590 illustrated in FIG. 23. Then, the communication control processing unit 461a resets the timer 4611a (S520).

After that, the communication control processing unit 461a checks whether or not the response 10591 is received via the network adapter 47 from the server network apparatus 105 (S521). In the processing in S521, in a case where the response 10591 is not received, the communication control processing unit 461a checks whether or not the value of the timer 4611a becomes larger than or equal to a predetermined period of time (whether or not time out occurs) (S522). According to the present embodiment, this predetermined period of time is set as 1 minute. That is, in the processing in S522 according to the present embodiment, the communication control processing unit 461a checks whether or not the timer 4611a indicates 1 minute or longer.

In the processing in S522, in a case where it is determined that time out does not occur, the communication control processing unit 461a shifts to the processing in S521. Also, in the processing in S522, in a case where it is determined that time out occurs, the communication control processing unit 461a shifts to the processing in S518.

As described above, the processing in S518 is the processing of adding one sequence ID, in a case where the processing is shifted from S522 to S518, with regard to the request 10590 of the normal command in S519, the content itself of the command 10590e is the same, but the sequence ID having a value larger than the value of the transmitted sequence ID by “1”.

In the processing in S521, in a case where it is determined that the response 10591 is received from the server network apparatus 105, the communication control processing unit 461a checks the sequence ID 10591d included in the response 10591 (S523). This processing is executed with the aim of carrying out the processing while responses other than the response 10591 corresponding to the request 10590 transmitted in the last place are invalidated similarly as in the processing in S508.

At this time, if the sequence ID 10591d included in the received response 10591 is different from the sequence ID stored in the sequence ID storage area 462, the communication control processing unit 461a shifts to the processing in S521.

Also, in the processing in S523, if the sequence ID 10591d included in the received response 10591 is the same as the sequence ID stored in the sequence ID storage area 462, the communication control processing unit 461a shifts to the processing in S524. That is, the communication control processing unit 461a checks whether or not the content of the received response 10591 indicates session time out (S524).

At this time, in a case where it is determined that the response 10591 indicates session time out, the flow shifts to the processing in S533. The processing in S533 is processing of discarding the session ID by deleting the session ID stored in the session ID storage area 463.

In S524, in a case where it is determined that the response 10591 does not indicate session time out, the communication control processing unit 461a controls the display control unit 48 and displays a processing result included in the response 10591 on a display 49 (S525).

Then, the communication control processing unit 461a adds “1” to the value of the sequence ID stored in the sequence ID storage area 462 for the update (S526). Then, the communication control processing unit 461a controls the network adapter 47 and adds the sequence ID stored in the sequence ID storage area 462 and the session ID stored in the session ID storage area 463 to transmit the request 10590 for the session release to the server management apparatus 105 (S527). Then, the communication control processing unit 461a resets the timer 4611a (S528).

After that, the communication control processing unit 461a checks whether or not the response 10591 is received via the network adapter 47 from the server network apparatus 105 (S529). In the processing in S529, in a case where the response 10591 is not received, the communication control processing unit 461a checks whether or not the value of the timer 4611a becomes larger than or equal to a predetermined period of time (whether or not time out occurs) (S530). According to the present embodiment, this predetermined period of time is set as 1 minute. That is, in the processing in S530 according to the present embodiment, the communication control processing unit 461a checks whether or not the timer 4611a indicates 1 minute or longer.

In the processing in S530, in a case where it is determined that time out does not occur, the communication control processing unit 461a shifts to the processing in S529. Also, in the processing in S530, in a case where it is determined that time out occurs, the communication control processing unit 461a shifts to the processing in S526.

Since the processing in S526 is processing of adding one sequence ID as described above, in a case where the processing is shifted from S530 to S526, with regard to the normal request 10590 in S527, the content itself of the command 10590e is the same, but the sequence ID having a value larger than the value of the transmitted sequence ID by “1”.

In the processing in S529, in a case where it is determined that the response 10591 is received from the server network apparatus 105, the communication control processing unit 461a checks the sequence ID 10591d included in the response 10591 (S531). This processing is executed with the aim of carrying out the processing while responses other than the response 10591 corresponding to the request 10590 transmitted in the last place are invalidated similarly as in the processing in S508.

At this time, when the sequence ID 10591d included in the received response 10591 is different from the sequence ID stored in the sequence ID storage area 462, the communication control processing unit 461a shifts to the processing in S529.

Also, in the processing in S531, if the sequence ID 10591d included in the received response 10591 is the same as the sequence ID stored in the sequence ID storage area 462, the communication control processing unit 461a shifts to the processing in S533. The processing in S533 is processing of discarding the session ID by deleting the session ID stored in the session ID storage area 463.

As will be understood from the above-mentioned processing, each time the request 10590 is transmitted, the supervisor terminal 4a according to the present embodiment adds 1 each to the value of the sequence ID 10590d. Also, if time out occurs, the supervisor terminal 4a transmits the same request 10590 where the value of the sequence ID 10590d is different. In addition, the processing of validating only the response 10591 including the same value as the sequence ID 10590d included the request 10590 transmitted in the last place.

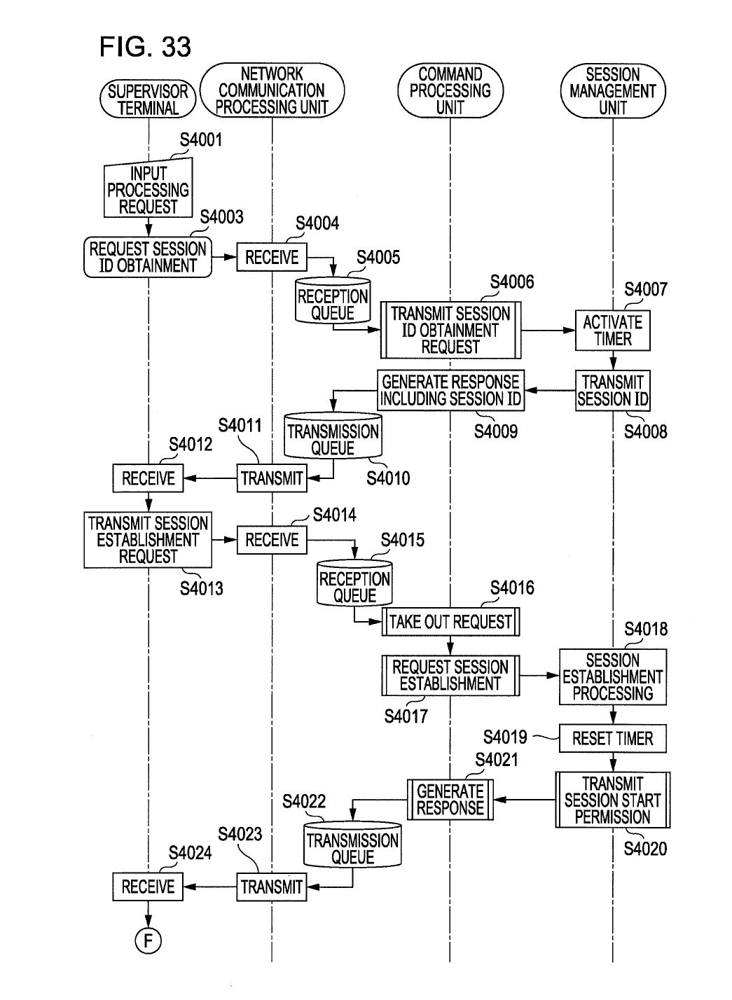

By using time charts in FIG. 33 and subsequent figures, a description will be given below of the processing by the server system 1 according to the present embodiment having the server management apparatus 105 including the supervisor terminal 4a or 4b, the command processing unit 1060a, and the session management unit 1061a which execute the above-mentioned processing will be described below. It is noted that in the following processing, the description will be given while taking the session with the supervisor terminal 4a as an example.

First, when the supervisor of the supervisor terminal 4a inputs a processing request (S4001), the request 10590 of the session ID obtainment request is transmitted via the network 3 for the supervisor to the server management apparatus 105 (S4003). The processing in S4001 to S4003 is based on the processing in S501 to S505 illustrated in FIG. 31.

The reception processing unit 10582 of the network communication processing unit 1058a that has received the request 10590 via the network adapter 1053 (S4004) stores the request 10590 in the reception queue 10581 (S4005).

When the request 10590 of this session ID obtainment request is taken out from the reception queue 10581, the command processing unit 1060a transmits the session ID obtainment request to the session management unit 1061a (S4006). The processing in S4005 by the command processing unit 2060a is based on the processing in S2006 to S2008 illustrated in FIG. 10.

The session management unit 1061a that has received the session ID obtainment request performs processing of activating the session timer 10611 (S4007) and also transmitting the response including the generated session ID to the command processing unit 1060a (S4008). The processing by the session management unit 1061a is based on the processing in S3003 to S3007 in FIG. 29.

When the response 10613 including the session ID is received, the command processing unit 2060a generates the response 10591 that includes the received session ID and is addressed to the supervisor terminal 4a (S4009) to be stored in the transmission queue 10583 (S4010). This processing is based on the processing in S2009 to S2011 in FIG. 10.

Then, the transmission processing unit 10584 of the network communication processing unit 1058a takes out the response 10591 from the transmission queue 10583 and controls the network adapter 1053 to be transmitted via the network 3 for the supervisor to the supervisor terminal 4a (S4011).

The supervisor terminal 4a that has received the response 10591 (S4012) thereafter transmits the request 10590 including the value of the session ID 10591c included in the response 10591. Also, the supervisor terminal 4a adds a unique request ID 10590d for each request 10590 to be transmitted.

Also, the supervisor terminal 4a that has received the response 10591 (S4012) transmits the request 10590 for the session establishment via the network 3 for the supervisor to the server management apparatus 105 (S4013). The processing in S4012 and S4013 is based on the processing in S506 to S513 in FIG. 31. The reception processing unit 10582 of the network communication processing unit 1058a that has received the request 10590 via the network adapter 1053 (S4014) stores the request 10590 in the reception queue 10581 (S4015).

After that, the command processing unit 1060a takes out the request 10590 (S4016), and when it is determined that the request is the request 10590 for the session establishment, the session establishment request is transmitted to the session management unit 1061a (S4017). This processing is based on the processing in S2012 to S2013 in FIG. 17.

The session management unit 1061a that has received this request checks the validity of the session (S4018) and thereafter resets the timer (S4019) to transmit the response 10613 to the command processing unit 1060a (S4020).

The command processing unit 1060a that has received the response 10613 (S4021) stores the response 10591 of the session establishment permission in the transmission queue 10583 (S4022). This processing is based on the processing in S2014 to S2017 in FIG. 17.

Then, the transmission processing unit 10584 of the network communication processing unit 1058a takes out the response 10591 from the transmission queue 10583 and controls the network adapter 1053 to be transmitted via the network 3 for the supervisor to the supervisor terminal 4a (S4023).

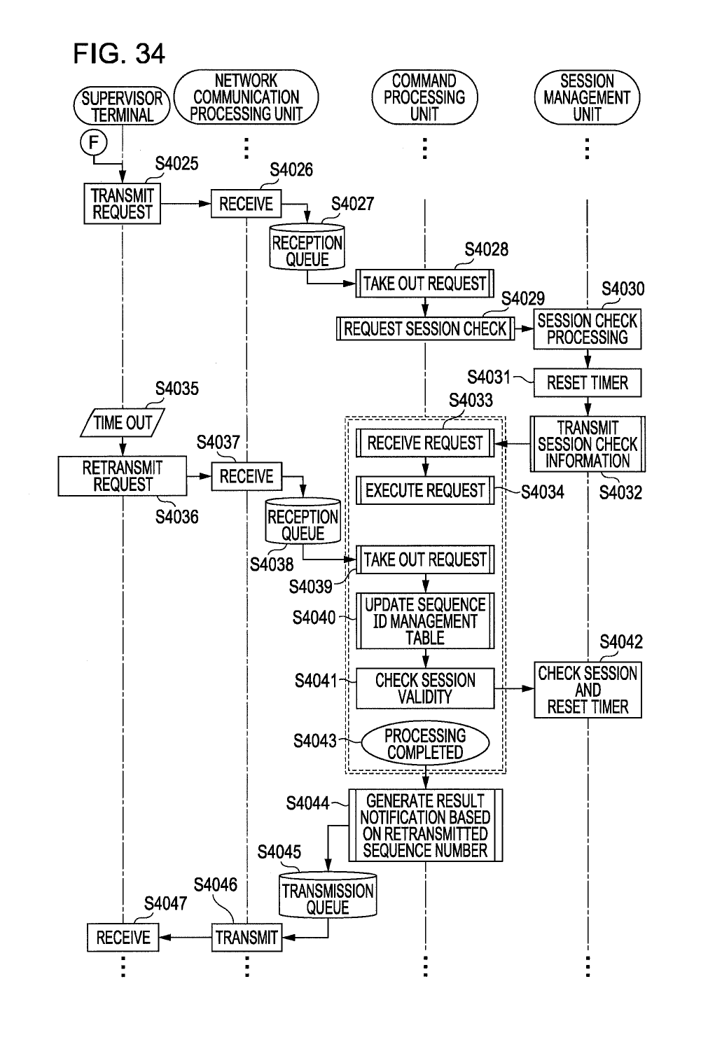

The supervisor terminal 4a that has received the response 10591 (S4024) transmits the request 10590 for the session establishment to the network 3 for the supervisor and transmits the normal request 10590 to the server management apparatus 105 (FIG. 34: S4025). The processing in S4023 and S4024 is based on the processing in S514 to S520 in FIG. 31 and FIG. 32.

The reception processing unit 10582 of the network communication processing unit 1058a that has received the request 10590 via the network adapter 1053 (S4026) stores the request 10590 in the reception queue 10581 (S4027).

When the request 10590 is taken out from the reception queue 10581 (S4028), the command processing unit 1060a transmits the request 10602 of the check request on the session validity to the session management unit 1061a (S4029). This processing is based on the processing in S2018 and S2019 in FIG. 22.

Then, the session management unit 1061a that has received the request 10602 performs the check processing on the validity of the session (S4030) and also resets the session timer 10611 if the session is valid (S4031) to transmit the response 10613 of the check result to the command processing unit 1060a (S4032). This processing is based on the processing in S3014 to S3018 in FIG. 30.

When it is determined that the request 10590 different from the previous request is received from the supervisor terminal 4a, the command processing unit 1060a that has received the response 10613 performs the instruction to the respective devices with respect to the request 10590 (S4032). In the stage of the processing in S4032, since the same request 10590 is not transmitted before, the command processing unit 1060a performs the instruction in accordance with the request 10590 to the respective devices. This processing is based on the processing in S2020 to S2022, S2025, and S2026 in FIG. 22.

In a case where the response 10591 from the network communication processing unit 1058a is not received within a predetermined period of time (according to the present embodiment, within 1 minute), the supervisor terminal 4a has a function of performing processing of retransmitting the request 10590 that has been transmitted in the processing in S4025.

For this reason, in a case where the command processing unit 1060a takes much time to perform the processing with respect to the request 10590 and the response 10591 is not transmitted to the supervisor terminal 4a within 1 minute, the supervisor terminal 4a retransmits the transmitted request 10590 in the processing in S4025 (S4035, S4036). These processing operations are based on the processing in S518 to S522 in FIG. 32.

The reception processing unit 10582 of the network communication processing unit 1058a that has received the retransmitted request 10590 via the network adapter 1053 (S4037) stores the request 10590 in the reception queue 10581 (S4038).

The command processing unit 1060a takes out the request 10590 (S4039) and performs the request 10602 of the session check request to the session management unit 1061a (S4040). Also, when it is determined that the taken request 10590 is the same as the previous request 10590, the command processing unit 1060a does not perform the processing of the request 10590 (S4041). These processing operations are based on the processing in S2018 to S2022 and S2025 in FIG. 22.

Similarly as in the processing in S4030 to S4032, the session management unit 1061a performs the check on the validity of the session and the reset of the session timer 10611 (S4042).

After that, in the command processing unit 1060a, when the processing corresponding to the request 10590 transmitted from the supervisor terminal 4a is completed in S4025 (S4045), the command processing unit 1060a deletes the stored content of the sequence ID management table 10601 and thereafter generates the response 10591 of the processing result while being assigned with the retransmitted sequence ID (S4044). Then, the command processing unit 1060a stores the generated response 10591 in the transmission queue 10583 (S4045). This processing is based on the processing in FIG. 27.

After that too, until the request 10590 for the session release is transmitted from the supervisor terminal 4a, similar command processing is executed.

In this manner, in a case where it is determined that the request 10590 is retransmitted from the supervisor terminal 4a, the command processing unit 1060a performs the request 10602 of the check request on the session management unit 1061a to check whether or not a session 1061b is valid, but the processing corresponding to the request 10590 is not executed. Each time the request 10602 of the check request is received, the session management unit 1061a resets the session timer 10611, and therefore session time out does not occur if the supervisor terminal 4a or 4b performs the retransmission at an interval shorter than a period of time for session time out.

Then, the command processing unit 1060a stores both the previous sequence ID and the current sequence ID in the sequence ID management table 10601, and if the sequence ID 10591d of the response 10591 from the respective devices is matched with one of the sequence IDs, the response 10591 is valid. Furthermore, in a case where all pieces of information from the respective devices are collected, the response 10591 including the sequence ID 10590d assigned to the latest request 10590 from the supervisor terminal 4a or 4b is transmitted.

Through the above-mentioned series of processing operations, in a case where the request 10590 is retransmitted from the supervisor terminal 4a or 4b, the processing is not carried out on the retransmission, and on the basis of the information from the respective devices with respect to the previous same request 10590, the response 10591 to the supervisor terminal 4a or 4b is generated.

As described above, in a case where the request 10590 already being processed is retransmitted, since the server management apparatus 105 does not perform the processing of the retransmitted request 10590, the number of the transmissions of the request 10590 to the respective devices and the processing operations by the respective devices on the basis of the request 10590 are not increased.

Also, if simply the redundant processing by the retransmitted request 10590 is to be avoided, at a time point when the retransmitted request 10590 is sent, it is conceivable that the current processing is cancelled and the processing of the retransmitted request 10590 is newly started. However, as described above, the transmitted request 10590 is the request 10590 same as the previous request 10590. That is, in the case of the request 10590 where a prolonged time is used to an extent that time out of the supervisor terminal 4a occurs, even when the processing is carried out in response to the retransmitted request 10590, it is likely that time out occurs again in the processing of the retransmitted request 10590.

In view of the above, according to the present embodiment, by transmitting the response 10591 to the retransmitted request 10590 on the basis of the previous request 10590, a response speed to the apparently retransmitted request 10590 is increased, and it is possible to reduce the probability that the retransmitted request 10590 is sent again during the processing by the command processing unit 1060a.

Furthermore, the storage area for the command of the request 10590 transmitted in the previous time from the supervisor terminal 4a or 4b is provided in the sequence ID management table 10601, and the retransmission is determined through the comparison with the command in the request received by the supervisor terminal 4a or 4b.

According to this configuration, even if information for identifying of the retransmission of the retransmitted request 10590 is not added, according to the present embodiment, it is possible to determine whether or not the request 10590 sent from the supervisor terminal 4a or 4b is retransmitted.

It is noted that according to the present embodiment, the example has been illustrated in which the detections of the sensors installed in the respective devices are transmitted to the supervisor terminal 4a or 4b. However, in addition to the above, for example, the configuration may also be applied to a case in which the request 10590 of the control instruction on the respective devices such as the activation of the power supply apparatus 104 is received from the supervisor terminal 4a or 4b, and the server management apparatus 105 performs the control instruction to the respective devices and transmit the control result to the supervisor terminal 4a or 4b.

Also, according to the present embodiment, the example of the detection of the device and the sensor of the same type has been illustrated, but the configuration may be applied to a case in which results of a plurality of sensors are collected. In this case, instead of directly transmitting detection results themselves from the respective sensors to the supervisor terminal 4a or 4b, the server management apparatus 105 may analyze the detection results of the plurality of sensors and output the analysis result.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A server management apparatus that performs processing of collecting statuses of devices arranged in a target server system on the basis of a request received from an upper-level apparatus and transmits a result of the processing to the upper-level apparatus as a reply to the request, the server management apparatus comprising:
a communication controller configured to perform a communication with the upper-level apparatus; and
a processor configured, in a case where when the communication controller receives the request from the upper-level apparatus, a processing content of the request is the same as a processing content of a previously received request and a reply to the processing based on the previously received request has not been transmitted to the upper-level apparatus, to avoid starting the processing corresponding to the subsequently received request and continue the processing based on the previously received request.

2. The server management apparatus according to claim 1,
wherein the processor transmits a result of the processing based on the previously received request to the upper-level apparatus as a result of the processing based on the subsequently received request.

3. The server management apparatus according to claim 1, further comprising:
a storage unit configured to store the processing content of the request received from the upper-level apparatus,
wherein in a case where the communication controller receives a request,
the processor stores a processing content of the received request in the storage unit when the processing content of the request is different from the processing content stored in the storage unit, and
the processor determines that the processing content of the request is the same as the processing content of the previously received request when the processing content of the request is the same as the processing content stored in the storage unit.

4. A server management method for a server management apparatus to perform processing of collecting statuses of devices arranged in a target server system on the basis of a request received from an upper-level apparatus and transmit a result of the processing to the upper-level apparatus as a reply to the request, the server management method comprising:
receiving the request from the upper-level apparatus by a communication processor;
determining whether or not a processing content of the request is the same as a processing content of a previously received request and a reply to the processing based on the previously received request has been transmitted to the upper-level apparatus; and
in a case where it is determined as a result of a detection that the processing content of the request is the same as a processing content of a previously received request and a reply to the processing based on the previously received request has not been transmitted to the upper-level apparatus, through the processing by the server management apparatus, avoiding starting the processing corresponding to the subsequently received request and continuing the processing based on the previously received request, and transmitting a result of the processing based on the previously received request to the upper-level apparatus.

5. The server management method according to claim 4, further comprising:
transmitting the result of the processing based on the previously received request by the server management apparatus to the upper-level apparatus as a result of the processing based on the subsequently received request.

6. The server management method according to claim 4,
wherein the server management apparatus includes a storage unit configured to store the processing content of the request received from the upper-level apparatus, and the method further comprises after the receiving the request from the upper-level apparatus,
storing the processing content of the received request in the storage unit when the processing content of the request is different from the processing content stored in the storage unit, and
determining that the processing content of the received request is the same as the processing content of the previously received request when the processing content of the request is the same as the processing content stored in the storage unit.

7. A static recording medium recording a server management program that causes a server management apparatus to execute a server management method of performing processing of collecting statuses of devices arranged in a target server system on the basis of a request received from an upper-level apparatus and transmitting a result of the processing to the upper-level apparatus as a reply to the request, the server management program that causes the server management apparatus to execute:
when a communication controller receives the request from the upper-level apparatus, in a case where a processing content of the request is the same as a processing content of a previously received request and a reply to the processing based on the previously received request has not been transmitted to the upper-level apparatus, avoiding starting the processing corresponding to the subsequently received request and continuing the processing based on the previously received request; and
transmitting a result of the processing based on the previously received request to the upper-level apparatus.

8. The recording medium according to claim 7,
wherein the server management program causes the server management apparatus to further execute transmitting the result of the processing based on the previously received request to the upper-level apparatus as a result of the processing based on the subsequently received request.

9. The recording medium according to claim 7,
wherein the server management apparatus includes a storage unit configured to store the processing content of the request received from the upper-level apparatus by executing processing based on the server management program, and in a case where the server management apparatus receives the request from the upper-level apparatus, the server management program causes the server management apparatus to further execute
storing the processing content of the received request in the storage unit when the processing content of the request is different from the processing content stored in the storage unit, and
determining that the processing content of the received request is the same as the processing content of the previously received request when the processing content of the request is the same as the processing content stored in the storage unit.
